(19) United States
(12) Patent Application Publication
(10) Pub. No.: US 2025/0379703 A1
(43) Pub. Date: Dec. 11, 2025

(54) TRIGGER FRAMES FOR WIRELESS NETWORK

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Bilal Sadiq, Plano, TX (US); Rubayet Shafin, Allen, TX (US); Peshal Nayak, Plano, TX (US); Yue Qi, Plano, TX (US)

(21) Appl. No.: 19/224,293

(22) Filed: May 30, 2025

Related U.S. Application Data
(60) Provisional application No. 63/658,148, filed on Jun. 10, 2024.
(60) Provisional application No. 63/677,503, filed on Jul. 31, 2024.
(60) Provisional application No. 63/727,888, filed on Dec. 4, 2024.
(60) Provisional application No. 63/728,986, filed on Dec. 6, 2024.

(51) Int. Cl. H04L 5/00; H04W 84/12

(52) U.S. Cl. CPC H04L 5/0053; H04W 84/12

(57) ABSTRACT

A trigger frame recipient includes a memory and a processor, the processor to receive, from a trigger frame transmitter, a trigger frame that solicits one or more responses from the trigger frame recipient, where the trigger frame includes a common information field providing information that is common to the trigger frame, one or more user information fields where each user information field provides information that is specific to the trigger frame recipient, and one or more special user information fields The processor is further to decode the trigger frame and determine a respective one of a plurality of communication protocol versions associated with the common information field based on (i) a first bit and a second bit of the common information field and (ii) a version information subfield of a special user information field, the version information subfield indicating a particular communication protocol version.

### CROSS-REFERENCE TO RELATED APPLICATION(S)

This application claims the benefit of priority from U.S. Provisional Application No. 63/658,148, entitled “EXPANDING THE COMMON AND USER-SPECIFIC INFORMATION FIELDS IN TRIGGER FRAMES,” filed Jun. 10, 2024; U.S. Provisional Application No. 63/677,503, entitled “EXPANDING THE COMMON AND USER-SPECIFIC INFORMATION FIELDS IN TRIGGER FRAMES,” filed Jul. 31, 2024; U.S. Provisional Application No. 63/727,888, entitled “EXPANDING THE COMMON AND USER-SPECIFIC INFORMATION FIELDS IN TRIGGER FRAMES,” filed Dec. 4, 2024; and U.S. Provisional Application No. 63/728,986, entitled “EXPANDING THE COMMON AND USER-SPECIFIC INFORMATION FIELDS IN TRIGGER FRAMES,” filed Dec. 6, 2024, all which are incorporated herein by reference in their entirety.

### TECHNICAL FIELD

This disclosure relates generally to a wireless communication system, and more particularly to, for example, but not limited to, trigger frames in wireless communication systems. Some aspects are related to expanding a common information field and user-specific information field in trigger frames.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5GHZ, 6GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

In some examples, the AP or STA can transmit trigger frames to allocate resources for and solicit one or more trigger based (TB) physical layer protocol data units (PPDU)—e.g., trigger frames can be used to support communication between the AP and one or more STAs. In some embodiments, the trigger frames can include a common information field and a user information field. Conventional solutions may have limited remaining fields for the common information field and user information field. Accordingly, a mechanism to accommodate new features in the IEEE 802.11 family of standards by extending the common information field and the user information field is desired.

The description set forth in the background section should not be assumed to be prior art merely because it is set forth in the background section. The background section may describe aspects or embodiments of the present disclosure.

### SUMMARY

An aspect of the present disclosure provides for a trigger frame recipient including a memory and a processor coupled to the memory. The processor is to cause receive, from a trigger frame transmitter, a trigger frame that solicits one or more responses from the trigger frame recipient, wherein the trigger frame includes a common information field, one or more special user information fields, and one or more user information fields, wherein the common information field and the one or more special user information fields provide information that is common to one or more trigger frame recipients of the trigger frame and each user information field provides information that is specific to the trigger frame recipient identified by the user information field and decode the trigger frame, wherein the processor is configured to determine a communication protocol version associated with the common information field based on (i) a first bit and a second bit of the common information field and (ii) a version information subfield of a special user information field, the version information subfield indicating a particular communication protocol version.

In an embodiment, the first bit and the second bit of the common information field indicate whether the common information field is associated with a first communication protocol.

In an embodiment, the version information subfield indicates whether the common information field is associated with a second communication protocol or a third communication protocol.

In an embodiment, the version information subfield indicates the common information field is associated with a second communication protocol of the plurality of communication protocol versions different than the first communication protocol.

In an embodiment, the processor is further to determine a communication protocol version associated with a user information field of the one or more user information fields based on at least one of (i) the first bit of the common information field, (ii) a third bit of the user information field, and (iii) the version information subfield of the specific user information field.

In an embodiment, the first bit of the common information field and the third bit of the user information field indicate whether the user information is associated with a first communication protocol.

In an embodiment, the version information subfield indicates whether the user information field is associated with a second communication protocol or a third communication protocol.

In an embodiment, the version information subfield indicates the user information field is associated with a second communication protocol of the plurality of communication protocol versions different than the first communication protocol.

In an embodiment, the plurality of communication protocols include a first communication protocol, a second communication protocol, and a third communication protocol, and wherein in a case that the processor determines the common information field is associated with the third communication protocol, a plurality of bits in the common information field have predetermined values to provide backwards compatibility with the first communication protocol or the second communication protocol.

In an embodiment, the processor is further to cause decode the version information subfield and determine a first communication protocol associated with the version information subfield, wherein the processor is configured to determine the first communication protocol based on a second communication protocol of the trigger frame recipient.

In an embodiment, the special user information field includes an indication of at least one of the presence of one or more follow up special user information fields that are present after the special user information field or the number of follow up special user information fields present after the special user information field.

In an embodiment, a user information field of the one or more user information fields includes an indication of at least one of the presence of one or more follow up user information fields that are present after the user information field and are addressed to the same trigger frame recipient or the number of follow up user information fields that are addressed to the same trigger frame recipient and are present after the user information field.

In an embodiment, a first user information field of the one or more user information fields is associated with a first association identification and a second user information field of the one or more user information fields is associated with a second association identification.

In an embodiment, the second user information field refrains from including trigger dependent user information.

In an embodiment, the common information field, the user information field, a follow-up user information field, the special user information field, or a follow-up special user information fields includes parameters associated with a non-primary channel access operation, a co-existence indication, or an intermediate frame check sequence (FCS).

An aspect of the present disclosure provides for a trigger frame transmitter in a wireless network including a memory and a processor coupled to the memory, the processor to cause generate a trigger frame that solicits one or more responses from one or more trigger frame recipients, wherein each of the one or more trigger frame recipients are associated with a respective one of a plurality of communication protocol versions, wherein the trigger frame includes a common information field, one or more special user information fields, and one or more user information fields, wherein the common information field provides information that is common to the one or more trigger frame recipients of the trigger frame and each user information field provides information that is specific to a particular trigger frame recipient of the one or more trigger frame recipients, wherein a communication protocol version associated with the common information field is indicated based on (i) a first bit and a second bit of the common information field and (ii) a version information subfield of a special user information field, the version information subfield indicating a particular communication protocol version and transmit, to the one or more trigger frame recipients, the trigger frame.

In an embodiment, the first bit and the second bit of the common information field indicate whether the common information field is associated with a first communication protocol and the version information subfield indicates whether the common information field is associated with a second communication protocol or a third communication protocol.

In an embodiment, the version information subfield indicates the common information field is associated with a second communication protocol of the plurality of communication protocol versions different than the first communication protocol.

In an embodiment, a communication protocol version associated with a user information field of the one or more user information fields is indicated based on (i) the first bit of the common information field, (ii) a third bit of the user information field, and (iii) the version information subfield of the specific user information field.

In an embodiment, the first bit of the common information field and the third bit of the user information field indicate whether the user information is associated with a first communication protocol and the version information subfield indicates whether the user information field is associated with a second communication protocol or a third communication protocol.

In an embodiment, the plurality of communication protocols include a first communication protocol, a second communication protocol, and a third communication protocol, and wherein in a case that the processor determines the common information field is associated with the third communication protocol, a plurality of bits in the common information field have predetermined values to provide backwards compatibility with the first communication protocol or the second communication protocol.

In an embodiment, the special user information field includes an indication of at least one of the presence of one or more follow up special user information fields that are present after the special user information field or the number of follow up special user information fields present after the special user information field.

In an embodiment, a user information field of the one or more user information fields includes an indication of at least one of the presence of one or more follow up user information fields that are present after the user information field and are addressed to the same trigger frame recipient or the number of follow up user information fields that are addressed to the same trigger frame recipient and are present after the user information field.

In an embodiment, the user information field is associated with a first association identification and the one or more follow up user information fields are associated with a second association identification.

In an embodiment, the one or more follow up user information fields refrain from including trigger dependent user information.

In an embodiment, the common information field, the user information field, a follow-up user information field, the special user information field, or a follow-up special user information fields includes parameters associated with a non-primary channel access operation, a co-existence indication, or an intermediate frame check sequence (FCS).

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example trigger frame in accordance with an embodiment.

FIGS. 5A and 5B show examples of a common information field in accordance with an embodiment.

FIG. 6 shows an example special user information field in accordance with an embodiment.

FIGS. 7A and 7B show example user information fields in accordance with an embodiment.

FIG. 8 shows an example trigger frame variant in accordance with an embodiment.

FIG. 9 shows an example MU-RTS trigger frame in accordance with an embodiment.

FIG. 10 shows an example BSRP trigger frame in accordance with an embodiment.

FIGS. 11A, 11B, and 11C show example expanded common information fields in accordance with an embodiment.

FIGS. 12A and 12B show example expanded user information fields in accordance with an embodiment.

FIG. 13 shows an example process for using an expanded common and user information field in trigger frames in accordance with an embodiment.

FIG. 14 shows another example process for using an expanded common and user information field in trigger frames in accordance with an embodiment.

FIG. 15 shows another example of a process for using expanded common and user information fields in trigger frames in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

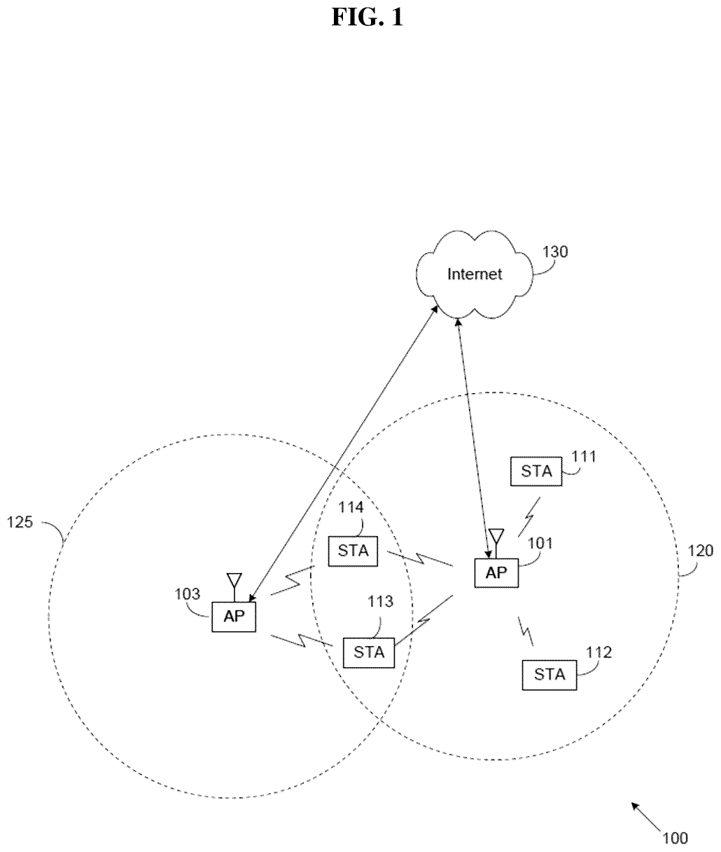

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

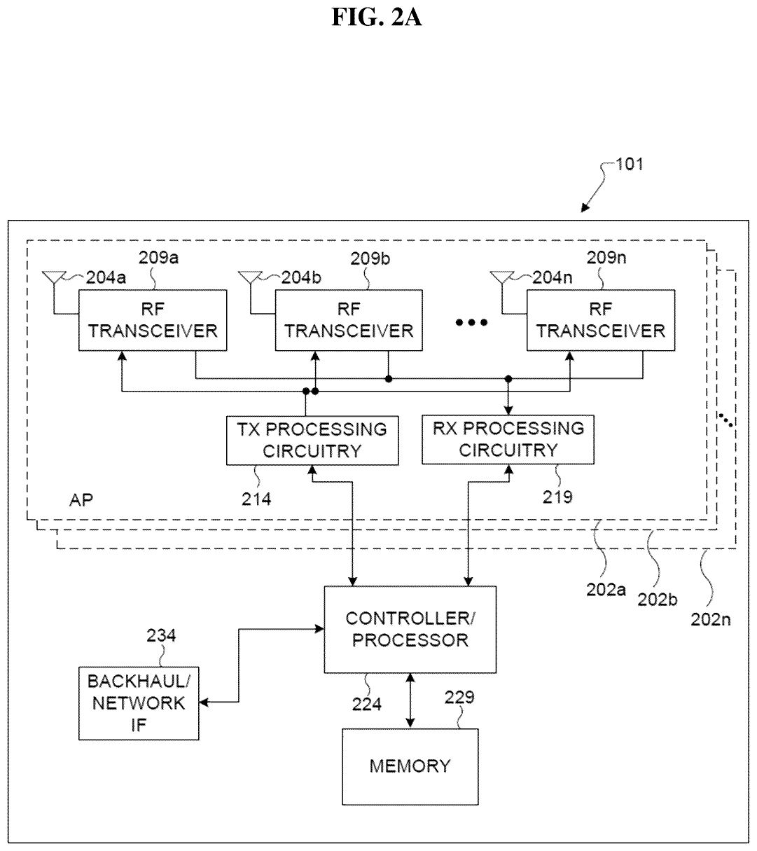

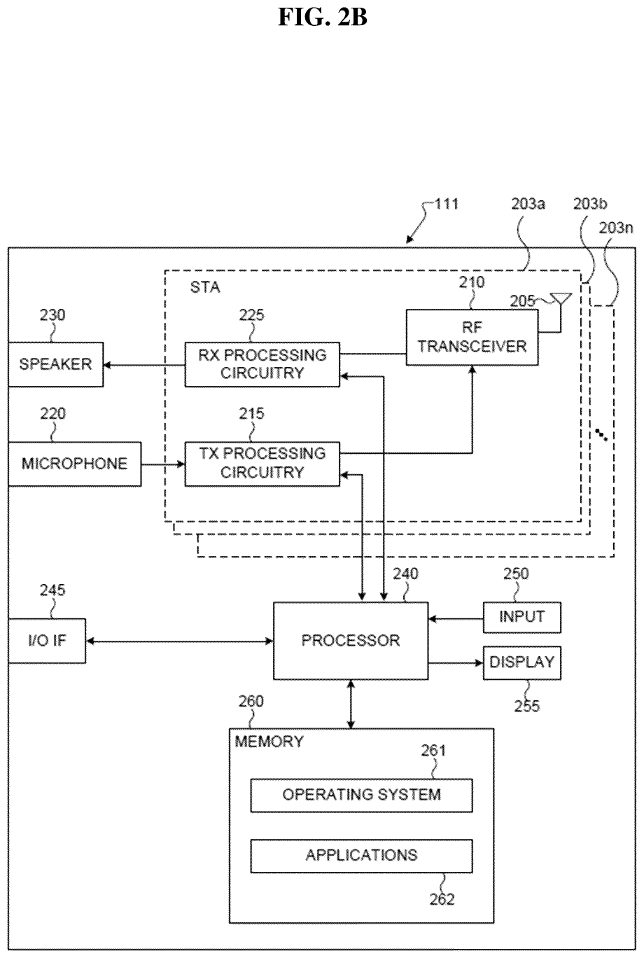

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

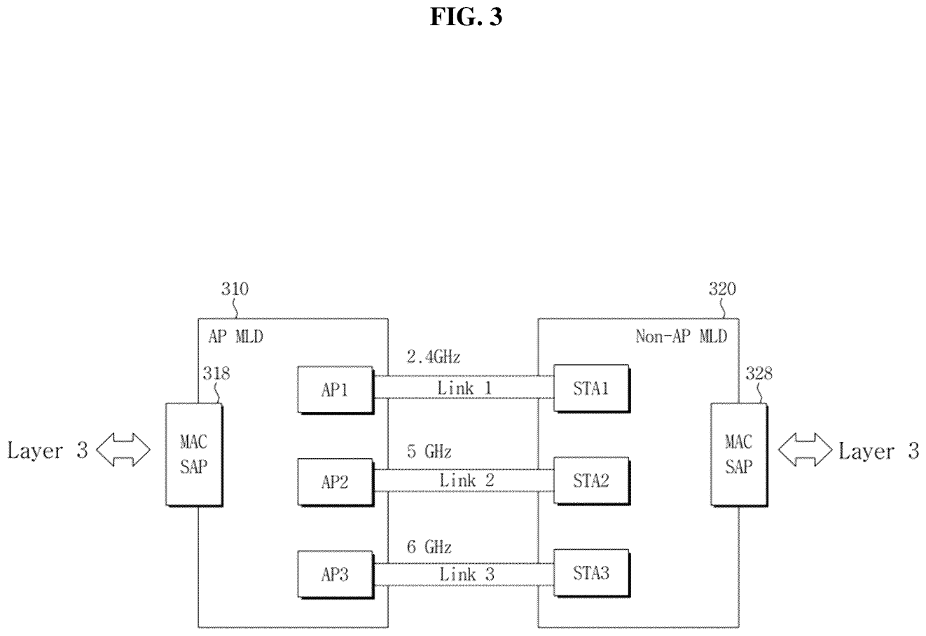

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.1, “Wireless LAN Medium Access Control (MAC) and Physical Layer (PHY) Specifications.”

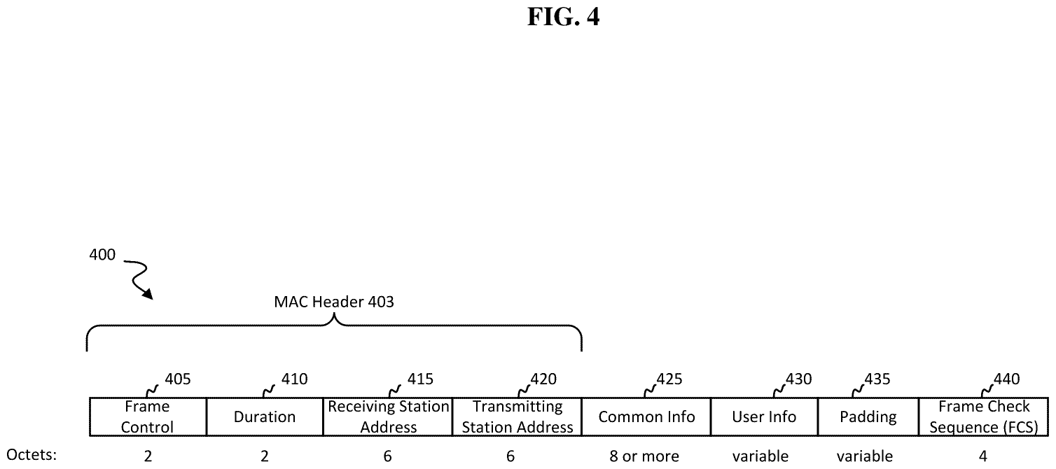

FIG. 4 shows an example trigger frame 400 in accordance with an embodiment. The trigger frame 400 depicted in FIG. 4 is for explanatory and illustration purposes and FIG. 4 does not limit the scope of this disclosure to any particular implementation. In some embodiments, the trigger frame 400 illustrated in FIG. 4 is a trigger frame used in conventional solutions.

In at least some embodiments, to support trigger-based communications between an access point (AP) and one or more stations (STAs) or between peers, the AP can utilize a trigger frame 400. In at least one embodiment, the trigger frame 400 can include a frame control 405, a duration 410, a receiving station address (RA) 415, a transmitting station address (TA) 420, a common information field 425, a user information field 430, padding 435, and a frame check sequence (FCS) 440. In at least one embodiment, the frame control 405, duration 410, RA 415, and TA 420 are considered as part of a medium access control (MAC) layer header 403.

In some embodiments, the frame control 405 can set the frame control field and consist of at least one of a following subfield; protocol version, type, subtype, to distribution system (DS) and from DS (e.g., indicating whether a data frame is destined for a distribution system or AP), more fragments, retry, power management, more data, protected frame, and/or order. In some embodiments, the duration field 410 is set as defined in 9.2.5 (See IEEE 802.11ax/D8.0 9.2.5). In at least one embodiment, the RA 415 sets an address of a recipient STA and TA 420 sets an address of a transmitting STA. In at least one embodiment, the padding 435 indicates a number of padding bytes. In some embodiments, FCS 440 includes an error detecting code used for error detection in a data transmission.

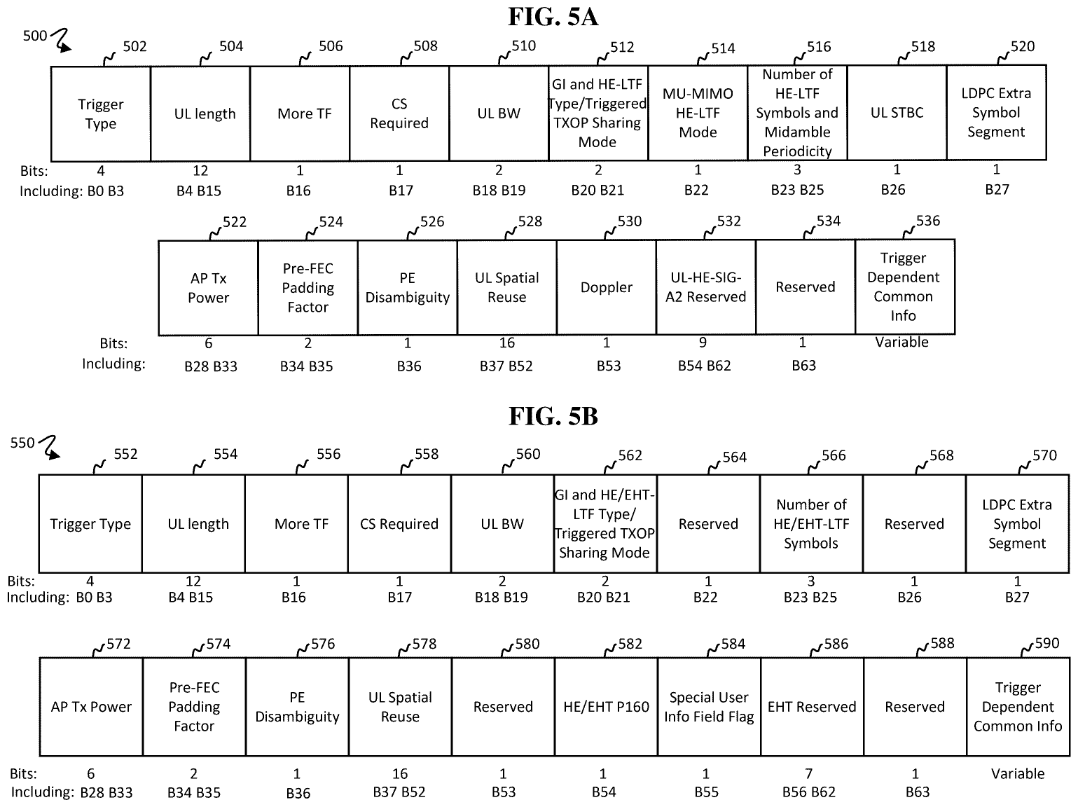

In one embodiment, the trigger frame 400 can include a common information field 425. In some embodiments, the common information field includes parameters that are common to all addressed STAs in the trigger frame 400. Additional details regarding the common information field 425 are discussed with reference to FIGS. 5A and 5B.

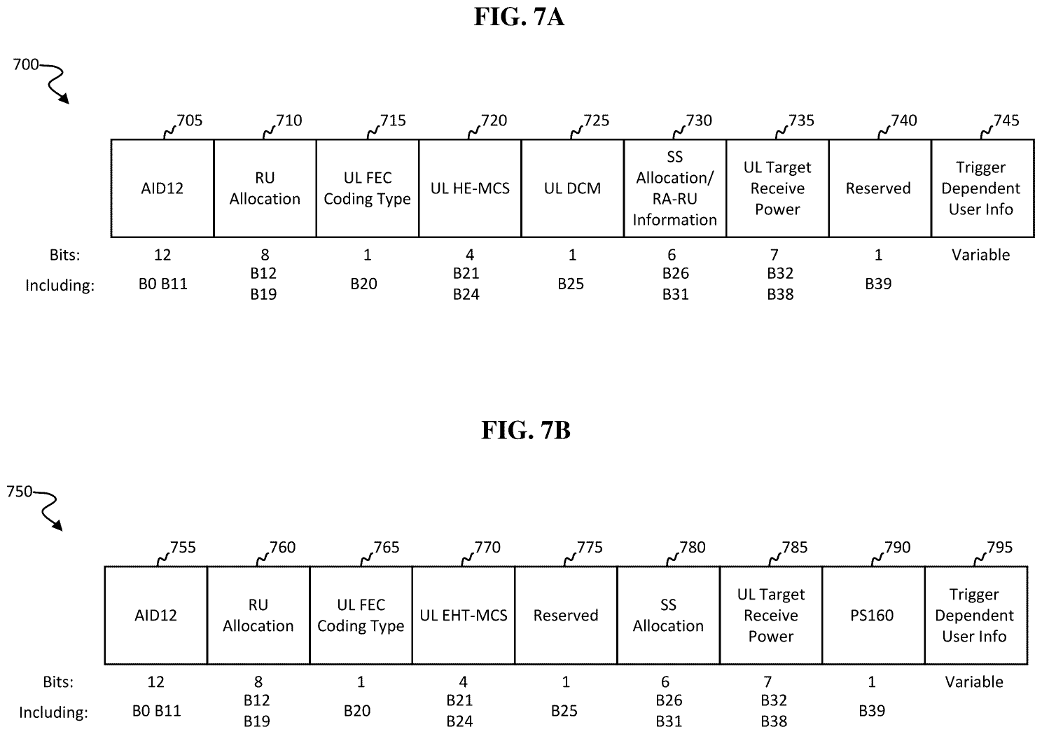

In at least one embodiment, the trigger frame 400 includes at least one user information field 430. In some embodiments, the user information field 430 includes information specific to differently addressed STAs. Additional details regarding the user information field 430 are described with reference to FIGS. 7A and 7B.

FIGS. 5A and 5B show examples of a common information field in accordance with an embodiment. The format depicted in FIGS. 5A and 5B is for explanatory and illustration purposes. FIGS. 5A and 5B do not limit the scope of this disclosure to any particular implementation.

In at least one embodiment, the common information field can have a different format depending on a variant or specification of the common information field. Each variant or specification may correspond to a specific generation of Wi-Fi technology. For example, FIG. 5A can illustrate a common information field for a high efficiency (HE) variant of the common information field. In one embodiment, FIG. 5B can illustrate a common information field for an extremely high throughput (EHT) variant of the common information field. That is, the trigger frame 400 can have a slightly different format depending on a version or edition of Wi-Fi technology available in an AP. In one embodiment, a non-EHT non-AP HE STA determines the common information field 500 as an HE variant common information field. In at least one embodiment, a non-AP EHT STA can interpret trigger frame 500 as an HE variant common information field if bits B54 and B55 illustrated in FIG. 5B in the common information field are equal to one (1). In such embodiments, the non-AP EHT STA can interpret trigger frame 500 as an EHT variant if bits B54 and B55 are not both equal to one (1)—e.g., if either or both of bits 54 and 55 are a zero (0). In some embodiments, an EHT AP can set bits B22, B26, B53, and B63 to a value zero (0) and set bits B56-62 as one (1) in the EHT common info field for backwards compatibility with the HE variant common information field.

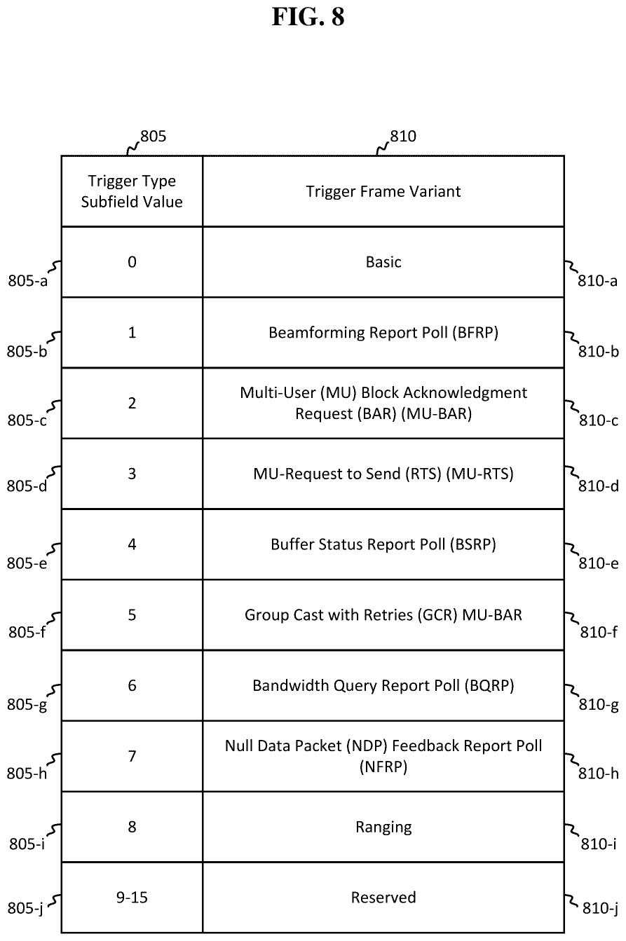

In some embodiments, the common information field 500 can include a trigger type 502. In some embodiments, the trigger type 502 can indicate a type of trigger frame as described with reference to FIG. 8. In some embodiments, the common information field 500 can also include a uplink (UL) length 504, a more trigger frame (TF) field 506, a carrier sense (CS) required field 508, a UL bandwidth (BW) field 510, guard interval (GI) and HE-long training field (LTF) type/triggered transmission opportunity (TXOP) sharing mode 512, multi-user multiple-input multiple-output (MU-MIMO) HE-LTF mode 514, a number of HE-LTF symbols and midamble periodicity 516, UL space-time block coding (STBC) 518, low-density parity-check (LDPC) 520, AP transmitting (Tx) power 522, pre-forward-error-correction (Pre-FEC) padding factor 524, packet extension (PE) disambiguity 526, UL spatial reuse 528, UL-HE-SIG-A2 (High efficiency signal A2) 532, reserved 534, and trigger dependent common information 536. In some embodiments, the UL length 504 indicates a desired length of the response frame to the trigger frame 500. In one embodiment, the more trigger frames (TF) field 506 indicates whether a subsequent trigger frame is scheduled for transmission. In at least one embodiment, the CS required field 508 indicates that STAs identified in a user information fields that should use energy detect (ED) to sense a medium before sending a response frame if the CS required field 508 is set to one (1′). In some cases, the UL BW 510 describes a bandwidth to be used for transmission of the response to the trigger frame 500. In some embodiments, this field can indicate a bandwidth of a frame carrying a multiple user (MU) request to send (RTS) trigger frame (MU-RTS trigger frame). In some embodiments, the GI and HE-LTF type/triggered TXOP shared mode 512 sets the GI and LTF type for the HE variant common information field 500. In some embodiments, the MU-MIMO HE-LTF mode 514 indicates a HE-LTF mode for an HE trigger based (TB) physical layer protocol data unit (PPDU) that has a resource unit (RU) that spans an entire bandwidth that is assigned to more than one non-AP STA. In some examples, the number of HE-LTF symbols and midamble periodicity 516 sets a number of LTF symbols present in the common information field 500. In one or more embodiments, the UL STBC 518 indicates a status of STBC encoding for solicited HE TB PPDUs. In some embodiments, the LDPC extra symbols 520 indicates a status of the LDPC extra symbol segment—e.g., a value one (1) indicates that the LDPC extra symbol segment is present and a value zero (0) indicates that the LDPC extra symbol segment is not present. In some embodiments, the AP Tx power field 522 indicates the AP's combined transmit power at a transmit antenna connector of all antennas used to transmit the triggering PPDU. In some embodiments, the pre-FEC padding factor 524 and the PE disambiguity 526 set a packet extension duration. That is, a first two bits indicate the pre-FEC padding factor and a third bit indicates the PE-disambiguity. In at least one embodiment, a UL spatial reuse 528 set a value for the spatial reuse field in the HE-SIG-A field. In one or more embodiments, the doppler 530 indicates whether a preamble is present—e.g., a value one (1) indicates that a midamble is present and a value zero (0) indicates that the midamble is not present. In some embodiments, the UL-HE-SIG-A2 reserved 532 carries a value to be included in a reserved field of the HE-SIG-A2 subfield. In one or more embodiments, the common information field 500 also includes trigger dependent common information 536.

In one embodiment, there is a reserved field 534 in the common information field 500. In one or more embodiments, the reserved field 534 includes one bit. That is, most of the bits aside from the reserved field 534 are utilized.

FIG. 5B illustrates a common information field 550 for an extremely high throughput (EHT) system or device. In some embodiments, the common information field 550 includes fields or information similar to common information field 500. For example, the common information field 550 can include a trigger type 552, UL length 554, a more TF 556, a CS required 558, a UL BW 560, a reserved field 564, a reserved field 568, an LDPC extra symbol segment 570, an AP Tx power 572, a pre-FEC padding factor 574, a PE disambiguity 576, a UL spatial reuse 578, a reserved field 580, and a reserved field 588. In some embodiments, the common information field 550 can also include additional information associated with the EHT device. For example, the common information field 550 can include a GI and HE/EHT-LTF type/triggered TXOP sharing mode 562, a number of HE/EHT-LTF symbols, HE/EHT P160 582, a special user information field flag 584, EHT reserved field 586, and trigger dependent common info 590. In some embodiments, the GI and HE/EHT-LTF type sets the GI and LTF type for the EHT variant common information field 550. In some embodiments, the number of HE/EHT-LTF symbols 566 sets a number of HE and EHT-LTF symbols present in the common information field 550. In some embodiments, the HE/EHT P160 582 can indicate a HE or EHT device.

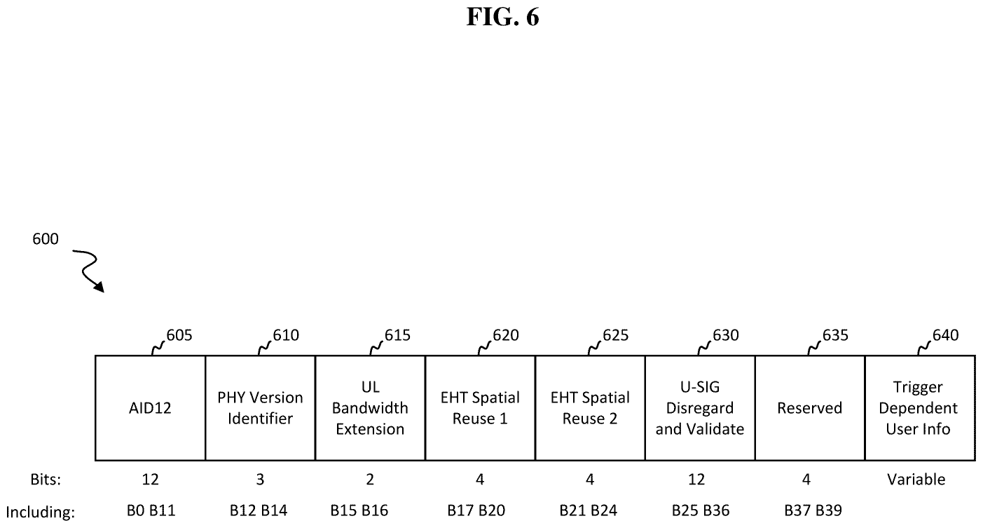

In one or more embodiments, common information field 550 can include limited reserved bits in the reserved field 564, reserved field 568, reserved field 580, reserved EHT field 586, and reserved field 588. In such embodiments, the UE can transmit additional information in a special user information field as described with reference to FIG. 6. In at least one embodiment, the special user information field flag 584 can indicate whether a special user information field is present—e.g., indicates that the next field received is a special user information field.

FIG. 6 illustrates a special user information field 600. The format depicted in FIG. 6 is for explanatory and illustration purposes. FIG. 6 does not limit the scope of this disclosure to any particular implementation.

In at least one embodiment, an AP or STA transmitting the trigger frame 400 can include additional common information that cannot be included in common information field 500 in a special user information field 600. In some embodiments, if the special user information field 600 is present, it is located immediately after the common information field 500 as described with reference to FIG. 5. In at least one embodiment, the special user information field 600 is defined as having an association identification (AID12) field 605 set to a value 2007 with the format depicted in FIG. 6. In at least one embodiment, the special user information field 600 can include a physical (PHY) version identifier 610, a UL bandwidth extension 615, an EHT spatial reuse 1 620, an EHT spatial reuse 2 625, a universal signal (U-SIG) disregard and validate field 630, a reserved field 635, and trigger dependent user information 640. In at least one embodiment, the PHY version identifier 610 can indicate a physical version associated with the response frame to the trigger frame 400. In at least one embodiment, the UL bandwidth extension 615 indicates a bandwidth of a solicited TB PPDU from the addressed EHT STA. In at least one embodiment, the EHT spatial reuse 1 620 and EHT spatial reuse 2 625 are set to a same value as a corresponding subfield in the U-SIG for the EHT TB PPDU. In some embodiments, the U-SIG disregard and validate field 630 carry a value to be included in a disregard and validate subfield of the U-SIG field of the solicited EHT TB PPDU. That is, mapping from the U-SIG disregard and validate subfield to bits in the U-SIG for a TB PPDU can be determined by on a table and the value of the U-SIG disregard and validate field 630.

FIGS. 7A and 7B show examples of a user information field in accordance with an embodiment. The format depicted in FIGS. 7A and 7B is for explanatory and illustration purposes. FIGS. 7A and 7B do not limit the scope of this disclosure to any particular implementation.

In at least one embodiment, the user information field can have a different format depending on a variant or specification of the user information field. In some examples, each variant or specification may correspond to a specific generation of Wi-Fi technology. For example, FIG. 7A can illustrate a user information field 700 for a high efficiency (HE) variant of the user information field. In one embodiment, FIG. 7B can illustrate a user information field 750 for an extremely high throughput (EHT) variant of the user information field. In at least one embodiment, the user information field 700 and user information field 750 have information that is specific to the STAs addressed by the user information.

In one embodiment, the user information field 700 can include an association identification (AID12) 705, a resource unit (RU) allocation 710, an uplink forward error correction (UL FEC) coding type 715, a UL HE modulation and coding scheme (HE-MCS) 720, a UL dual carrier modulation (DCM) 725, a spatial stream (SS) allocation/random access resource unit (RA-RU) information 730, a UL target receive power 735, a reserved field 740, and/or trigger dependent user information 745. In one embodiment, the RU allocation 710 depends on a size of a channel width. In some embodiments, the RU allocation 710 depends on a value of the UL bandwidth 510 of the common information field 500. For example, the RU allocation 710 can have BO have a value zero ‘0’ when the UL BW field 510 indicates 20 megahertz (MHz), 40 MHz, or 80 MHz PPDU. In at least one embodiment, the UL FEC coding type 715 indicates a code type of the solicited HE TB PPDU. In some embodiments, the UL FEC coding type subfield is set to zero ‘0’ to indicate a block check character (BCC) and is set to one ‘1’ to indicate a low-density parity-check (LDPC) code. In one or more embodiments, the UL-HE-MCS 720 indicates a HE-MCS of the solicited HE TB PPDU. In at least one embodiment, the UL DCM 725 indicates the DCM of the solicited HE TB PPDU. For example, the UL DCM 725 field is set to one ‘1’ if the DCM is used and is set to zero ‘0’ to indicate the DCM is not used. In some embodiments, the UL DCM subfield is set to zero ‘0’ if the UL SBTC 518 is set to one ‘1’. In some embodiments, the SS allocation and RA-RU information 730 can indicate a spatial stream of the solicited HE TB PPDU and the format. In some embodiments, the UL target receive power 735 can indicate an expected receive signal power, measured at the AP's antenna connector and averaged over the antennas. In some embodiments, the user information field 700 can include a reserved field 740 and trigger dependent user information 745.

FIG. 7B illustrates a user information field 750 for an extremely high throughput (EHT) variant of the user information field. In some embodiments, the user information field 750 includes fields or information similar to user information field 700. For example, the user information field 750 can include an AID12 755, RU allocation 760, UL FEC coding type 765, UL EHT-MCS 770, a reserved field 755, SS allocation 780, UL target receive power 785, PS160 790, and trigger dependent user information 795. In some embodiments, the UL EHT-MCS 770 can indicate a EHT-MCS of a solicited EHT TB PPDU. In at least one embodiment, the PS160 790 can indicate a HE or EHT device. In some embodiments, PS160 790 is a bit that indicates a primary or secondary 160 MHz channel for resource unit (RU) or multiple resource unit (MRU). In some examples, if the RU/MRU operates at a channel greater than 160 MHz, the PS160 790 can indicate a specific MRU and does not identify a primary or secondary channel.

For either the user information field 700 or the user information field 750, there are little reserved fields left for additional information. For example, both the user information field 700 and the user information field 750 include a single reserved bit for additional information.

FIG. 8 illustrates example trigger frame types in accordance with an embodiment. The format depicted in FIG. 8 is for explanatory and illustration purposes. FIG. 8 does not limit the scope of this disclosure to any particular implementation.

In some examples, subfields of a common information field or a user information field can be reserved or indicate certain types of trigger frames. In one embodiment, several different trigger frames are accepted as part of the IEEE family of standards. In some embodiments, these specific trigger frames types can be indicated as shown in FIG. 8.

For example, a trigger type subfield 805 having a value zero ‘0’ (e.g., the trigger type subfield 805-a) can be associated with a basic trigger frame variant 810-a. In one embodiment, the basic trigger frame allocates transmission resources to one or more STAs for trigger-based (TB) uplink transmission. In at least one embodiment, for the basic trigger frame variant 810-a, a trigger-dependent common information subfield (e.g. fields 536 or 590 as described with reference to FIG. 5) is not present in the common information field.

In some embodiments, a trigger type subfield 805-b having a value one ‘1’ can be associated with a beamforming report poll (BFPR) trigger frame variant 810-b. In at least one embodiment, the BFPR trigger frame initiates a beamforming process and obtains downlink channel state information (CSI) feedback from multiple STAs. In at least one embodiment, for the BFPR trigger frame variant 810-b, the trigger-dependent common information subfield (e.g. fields 536 or 590 as described with reference to FIG. 5) is not present in the common information field.

In at least one embodiment, a trigger type subfield 805-c having a value two ‘2’ can be associated with a multi-user (MU) block acknowledgment request (BAR) trigger frame variant 810-c. In some embodiments, the MU-BAR trigger frame solicits block acknowledgements for multiple STAs using orthogonal frequency division multiple-access (OFDMA) to which an AP has sent quality of service (QOS) data frames with a block acknowledgment policy or STAs from which the AP has not received immediate acknowledgement frames following the transmission of the QoS data frames with an HETP acknowledgment policy in the HE Multi-user (MU) PPDU. In some examples, for the MU-BAR trigger frame variant 810-c, the trigger-dependent common information subfield (e.g. fields 536 or 590 as described with reference to FIG. 5) is not present in the common information field.

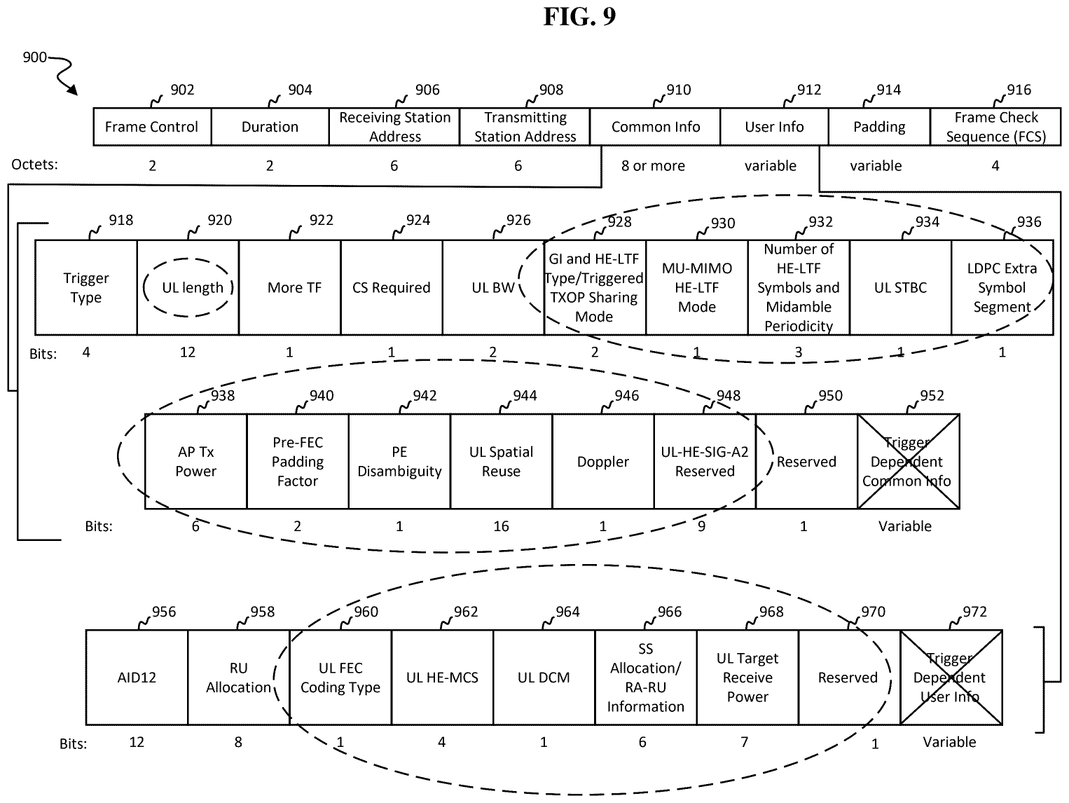

In at least one embodiment, a trigger type subfield 805-d having a value three ‘3’ can be associated with a multi-user (MU) request-to-send (RTS) trigger frame variant 810-d. In at least one embodiment, the MU RTS trigger frame solicits a clear-to-send (CTS) response from at least one of a multi-user capable STAs that are addressed by the MU-RTS frame. In at least one embodiment, the MU RTS trigger frame is beneficial for detecting hidden node situations for a multi-user transmission framework. In some cases, the MU-RTS frame is transmitted as a broadcast frame. In some embodiments, the MU-RTS frame is transmitted in a legacy non-HT duplicate physical protocol data unit (PPDU) format so that all STAs are able to decode the respective MU-RTS frame. In some embodiments, the MU-RTS and CTS procedure prevents hidden node issues and reserves a channel for MU transmissions. In one embodiment, the AP transmits a MU-RTS trigger frame and requests at least one non-AP STA to respond with a CTS on each 20 megahertz (MHz) channel where a transmit opportunity (TXOP) is won. In at least one embodiment, a format of a MU-RTS frame is illustrated with reference to FIG. 9. In one embodiment, the MU-RTS frame can include a common information field 910 and a user information field 912. In one embodiment, the common information field 910 indicates parameters that are common to all addressed STAs. For example, the common information field 910 can include bandwidth of the TXOP and how much each STA should respond to the MU-RTS frame. In some embodiments, the user information field 912 includes resource unit (RU) allocations 958 to one or more association IDs (AIDs) 956. In one embodiment, bits B0-B7 of the RU allocation 958 indicate a location of an X MHz primary channel where the CTS should be sent. In some embodiments, after successful reception of the CTS, the AP can transmit a HE TB PPDU. In one embodiment, the UL BW field 926 of the common information field 910 indicates a bandwidth (BW) of the TB PPDUs that follow. In some cases, the AP can wait for a CTS timeout interval to see if a response is obtained. In one example, if there is no response obtained, the AP can assume the MU-RTS has failed and the AP may initiate a point coordination function (PCF) interframe space (PIFS) recovery or the AP can back off. In other cases, when the STA does respond to the MU-RTS frame, the STA can ensure that a transmission start time of the response frame is within ±0.4 microseconds (μs) +16 us from an end, at the STA's transmit antenna connector, of the last OFDM symbol of the triggering PPDU (e.g., if the triggering PPDU contains no packet extension (PE) field) or of the PE field of the triggering PPDU (e.g., if the PE field is present). In some embodiments, the responding STA is also required to compensate for carrier frequency offset (CFO) errors and symbol clock errors with respect to the triggering PPDU when transmitting the response. In some embodiments, the residual CFO after correction can be below 2 kilohertz (KHz) for an MU-RTS frame 900. In at least one embodiment, several subfields of the common information field 910 or the user information field 912 are not present or reserved. For example, the UL length 920 GI and HE-LTF type/triggered TXOP sharing mode field 928, MU-MIMO HE-LTF mode 930, number of HE-LTF symbols and midamble periodicity 932, UL STBC 934, LDPC extra symbol segment 936, AP Tx power 938, pre-FEC padding factor 940, PE disambiguity 942, UL spatial reuse 944, doppler 946 and UL-HE-SIG A2 reserved 948 of the common information field 910 be reserved fields for the MU-RTS trigger frame 900. Additionally, the UL FEC coding type 960, the UL HE-MCS 962, the UL DCM 964, the SS allocation/RA-RU information 966, UL target receive power 968, and reserved 970 of the user information field 912 are also reserved. In some embodiments, the trigger dependent common information 952 and the trigger dependent user information 972 are not present for the MU-RTS frame 900.

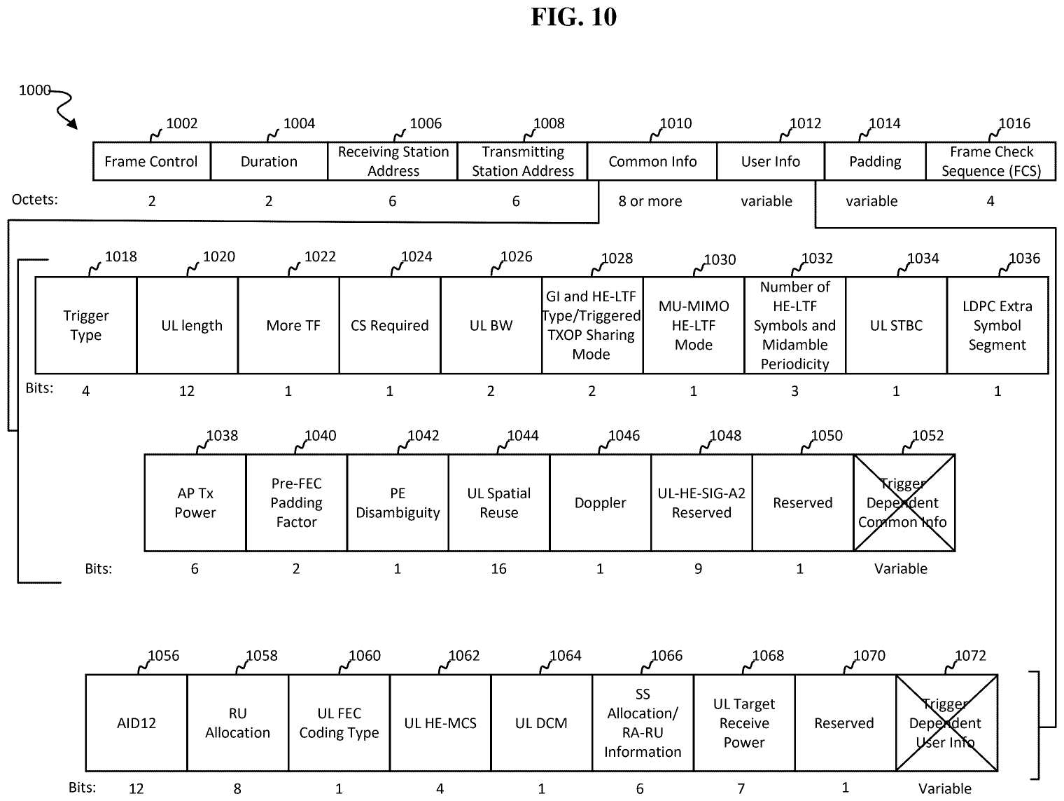

Referring back to FIG. 8, in at least one embodiment, a trigger type subfield 805-e having a value four ‘4’ can be associated with a buffer status report poll (BSRP) trigger frame variant 810-e. In one embodiment, the BSRP trigger frame triggers an uplink response from one or more MU capable STAs that are addressed by the BSRP trigger frame via OFDMA. In at least one example, a response to the BSRP trigger frame includes an uplink Buffer Status Report corresponding to different traffic categories at the responding STAs. In some cases, the STA response is useful for the triggering device (e.g., an AP) to subsequently assign uplink resources for the responding SSTAs for their trigger-based uplink transmissions. In one embodiment, a format of the BSRP trigger frame is illustrated with reference to FIG. 10—e.g., a BSRP trigger frame 1000. For example, each addressed STA by the BSRP trigger frame has a corresponding user information field in the BSRP trigger frame and the RU allocation field 1058 of the user information field 1012 indicates a set of resource units (RUs) on which the STA is expected to transmit the response frame on. In at least one embodiment, when the STA does respond to a BSRP trigger frame 1000, the STA is expected to ensure that a start time of the response frame is within ±0.4 microseconds (μs)+16 μs from an end, at the STA's transmit antenna connector, of the last OFDM symbol of the triggering PPDU (e.g., if the triggering PPDU contains no packet extension (PE) field) or of the PE field of the triggering PPDU (e.g., if the PE field is present). In some embodiments, the responding STA is also required to compensate for carrier frequency offset (CFO) errors and symbol clock errors with respect to the triggering PPDU when transmitting the response. In some embodiments, the residual CFO after correction can below 300 hertz (Hz) for an BSRP trigger frame 1000. In at least one embodiment, several subfields of the common information field 910 or the user information field 912 are not present. For example, the trigger dependent common information 1052 of the common information field 1010 and the trigger dependent user information 1072 of user information field 1012 are not present for the BSRP trigger frame 1000.

Referring back to FIG. 8, in at least one embodiment, a trigger type subfield 805-f having a value five ‘5’ can be associated with a group cast with retries (GCR) MU-BAR frame variant 810-f. In some embodiments, the GCR MU-BAR trigger frame solicits block acknowledgements from multiple STAs using OFDMA to which the AP has sent group-addressed QoS data frames with a GCR block acknowledgment agreement. In at least one embodiment, the GCR MU-BAR trigger frame does not include a trigger-dependent user information subfield in the user information field.

In some embodiments, a trigger type subfield 805-g having a value six ‘6’ can be associated with a bandwidth query report poll (BQRP) trigger frame variant 810-g. In at least one embodiment, the BQRP trigger frame solicits bandwidth query reports (BQRs) from one or more STAs. In at least one embodiment, each BQR indicates a 20 MHz sub-bands of a total trigger frame bandwidth, that are observed by the transmitting STA as idle. In some embodiments, the BSRP trigger frame does not include a trigger dependent common information subfield in the common information field and does not include the trigger dependent user information subfield in the user information field.

In at least one embodiment, a trigger type subfield 805-h having a value seven ‘7’ is associated with a null data packet (NDP) feedback report poll (NFRP) trigger frame variant 810-h. In some embodiments, the NFRP trigger frame solicits NDP feedback report responses from multiple STAs within a range of association identifiers (AIDs), where the report contains information on the resources required by the STAs for their trigger-based uplink transmissions. In at least one embodiment, for NFRP trigger frames, the UL STBC, LDPC extra symbol segment, pre-FEC padding factor, PE disambiguity, UL spatial reuse, and doppler subfields of the common information field are reserved and the trigger dependent common information subfield is not present. In at least one embodiment, the user information field of the NFRP trigger frame has a format different than the user information field depicted in FIG. 6.

In one or more embodiments, a trigger type subfield 805-i having a value eight ‘8’ is associated with a ranging trigger frame variant 810-i. In at least one embodiment, the ranging trigger frame is transmitted to initiate range measurements—e.g., the trigger frame can be used for a MU ranging measurement procedure. In some embodiments, the ranging trigger frame can be used for ranging negotiations.

In at least one embodiment, additional trigger type subfields 805—j (e.g., having a value 9-15) are currently reserved and are not associated with a trigger frame variant 810.

In some embodiments, trigger frames are anticipated to be used in the 802.11bn standard. That is, additional proposals have proposed the use of trigger frames for multi-AP coordination for obtaining cross-basic service set (BSS) channel state information (CSI), buffer status, resource allocation, etc. Additional use for trigger frames can include coexistence indications, initiating a switch to a higher capability state in an AP dynamic power save (DPS) operation, initiating dynamic sub-band operation (DSO) sub-band switch or initiating transmission on backup primary channels in a non-primary channel access (NPCA) operation. These operations can affect or focus on the MU-RTS trigger frame, MU-RTS TXS trigger frames, BRSP trigger frames, BQRP trigger frames, FRP trigger frames. Accordingly, these frames will have additional fields that need to be defined for both user and common information fields of the trigger frames in 802.11bn.

That is, there very few reserved fields left in either the common information field or the user information field for the trigger frames. Although special user information fields have been proposed to extend the common information field further as EHT trigger frames grow, new features in ultra-high reliability (UHR) may need additional fields for the common information field, which can also require a new format for the field (e.g., to ensure that legacy devices can still receive messages). That is, the current solutions implement a single special user information field and that field also has little reserved bits left for additional information. Similarly, there are few remaining fields in both the HE and EHT formats of the user information fields for trigger frames. Accordingly, to accommodate the new features in UHR (e.g., for multi-AP coordination, peer-to-peer coordination, coexistence indication, resource pre-allocation, dynamic sub-band operations, dynamic power save operations, non-primary channel access operations, etc.), way to extend the size of the user information field and the common information field are desirable. Current mechanisms to indicate the common information field and or the user information field as being an HE variant or an EHT variant is not amenable for easy expansion to identify future versions like UHR variant fields.

As described herein, a way for increasing a size of the common information field, carried in the common information field and special user information field, and the user-specific information carried in the user information field, of triggers frames to help support new use cases proposed in 802.11bn and beyond is provided. Additionally, mechanisms for easy identification of a version of the common information field and the user information field present in the trigger frames is described herein.

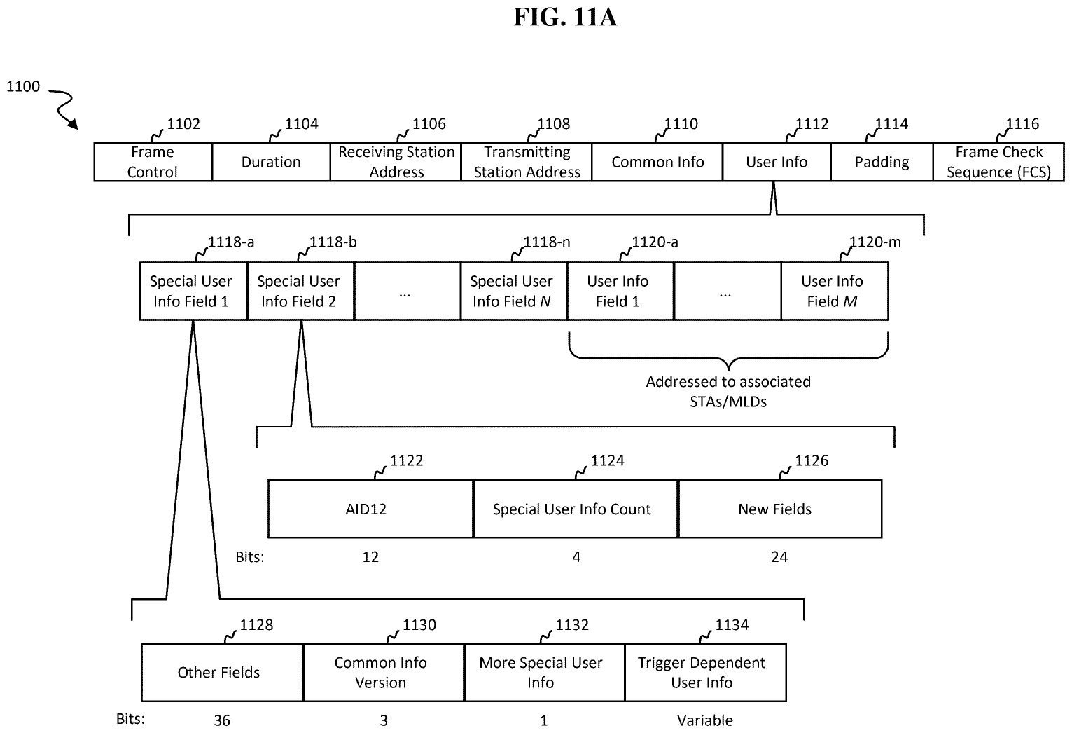

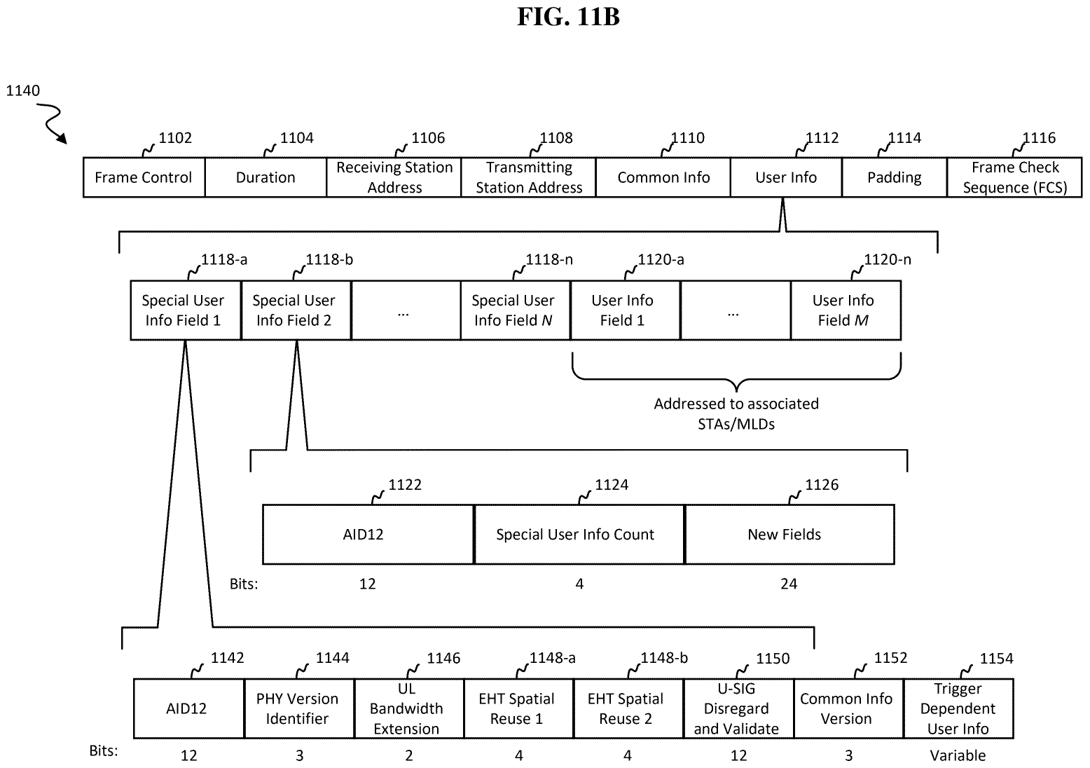

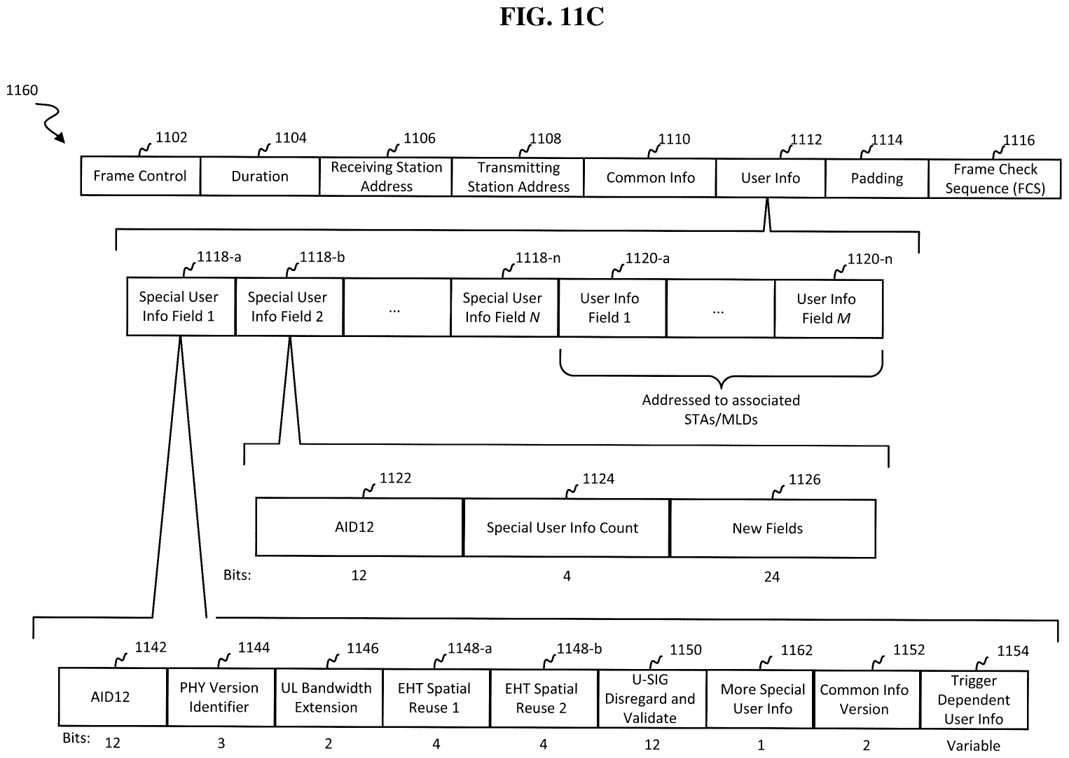

FIGS. 11A, 11B, and 11C illustrate extended common information fields in accordance with embodiments herein. The format depicted in FIGS. 11A, 11B, and 11C is for explanatory and illustration purposes. FIGS. 11A, 11B, and 11C do not limit the scope of this disclosure to any particular implementation. Additionally, while some of the following embodiments discuss enhancements made to support 802.11bn or discuss ultra-high reliability (UHR) devices and specifications, the proposed solutions are not limited thereto. That is, the proposed solution can be implemented to be used for any future WiFi standard that relies on utilizing additional fields in the Trigger frames. Similarly, while some proposed embodiments discuss a trigger frame transmitted by an access point (AP) to a non-AP station (STA), the proposed solutions are not limited thereto. In some embodiments, the proposed solutions are appliable for triggers frames transmitted by a non-AP STA to the AP or from a first STA to a second STA. Further, although some embodiments discuss or propose specific fields for carrying indications, the indications can be indicated in other fields too or in a different format. Accordingly, such specific fields should be interpreted as examples and are not limitations on the embodiments or on the claims.

Referring to FIG. 11A, an extended common information field is shown. In one embodiment, FIG. 11A includes a trigger frame 1100. In such embodiments, the trigger frame 1100 can include a frame control 1102, a duration 1104, a receiving station address 1106, a transmitting station address 1108, common information field 1110, user information field 1112, padding 1114, and frame check sequence (FCS) 1116. In at least one embodiment, the user information field 1112 can include one or more special user information fields 1118 and user information fields 1120—e.g., special user information field 1 1118-a, special user information field 2 118-b, special user information field N 1118-n, user information field 1120-a, and user information field M 1120-m. In one embodiment, a special user information field 1118 can include an association ID (AID12) 1122, special user information count 1124, and new fields 1126—e.g., the special user information field 1118-b can include the AID 12 1112, special user information count 1124, and the new fields 1126. In some embodiments, a special user information field (e.g., special user information field 1118-a) can include other fields 1128, common information version 1130, more special user information 1132 and trigger dependent user information 1134. In at least one embodiment, the common information version 1130 can be referred to as a physical layer (PHY) version identifier. In such embodiments, the PHY version identifier subfield can indicate the variant of the common information field 1110 that is not an HE variant.

In one embodiment, a special user information field 1118 that includes an AID12 1122 having a value of ‘2007’ can have a common information version field that indicates the version of the common information field format is the one depicted in FIG. 11A. In some examples, a device operating with a different version of Wi-Fi can interpret the common information field differently. For example, a non-AP UHR STA interprets the common information field as a high efficiency (HE) variant common information field if a bit 54 (B54) and a bit 55 (B55) are equal to one ‘1’ and when bit B54 and bit B55 are not both equal to one, interprets the common information field as an extremely high throughput (EHT) or UHR variant common information field according to a physical (PHY) version identifier subfield (e.g., common information version 1130) in the special user information field 1118. In other embodiments, a common information version equal to zero ‘0’ can imply the version is EHT and common information version equal to one ‘1’ can imply that the version is UHR. In some embodiments, the common information version field is a new field (e.g., common information version 1130). In other embodiments, the common information version field 1130 can be carried in the common information field 1110 or in a new special user information field 1118 with an AID12 different than 2007 (e.g., having a value 2006 or 2008) of the trigger frame. In some embodiments the trigger frame 1110 can include a physical version identifier subfield (e.g., physical version identifier 1144 as described with reference to FIG. 11B and 11C). In such embodiments, the PHY version identifier 1144 indicates a physical layer (PHY) version of a solicited trigger-based (TB) physical layer protocol data unit (PPDU) that is not a HE TB PPDU. In one embodiment, the PHY version identifier subfield 1144 is set to zero ‘0’ for EHT or set to one ‘1’ for UHR. In some embodiments, values two to seven ‘2-7’ are reserved. That is, a future version of Wi-Fi can utilize the reserved values to indicate a particular PHY version. In some embodiments, the bit numbers described herein can be based on the common information fields described with reference to FIGS. 5A and 5B. In at least one embodiment, the bit B54 and bit B55 can be included in a HE/UHR P160 field and special user information field flag of a UHR common information field, respectively. In at least one embodiment, bit 39 can be located in a PS160 field of the UHR user info field variant.

In other embodiments, some of the bits in the common information field 1110 can be set to specific values to indicate whether the common information version of the common information field 1110 is UHR or EHT, or so on. For example, bits B22, B26, B53, B56-B62, B63 can be set to specific values. In one example, bit B65 can be set to a value zero ‘0’ to indicate that the common information version is UHR.

In one embodiment, the common information version field is defined. In such embodiments, a UHR STA can identify a common information field 1110 as a UHR common information field if bits B54 and B55 in the common information field 1110 are not both equal to ‘1,’ and the common information version field 1130 is set to indicate UHR. In such embodiments, a non-AP UHR STA interprets the common information field as an HE variant if bits B54 and B55 in the common information field 1110 are both equal to one ‘1’ and interprets the common information field as an EHT or UHR variant common information field 1100 according to the common information version 1130 in the special user information field 1118.

In some embodiments, any HE STA can identify a common information field 1100 in a trigger frame as a HE common information field. In at least one embodiment, a non-AP EHT STA can interpret the common information field 1100 as an HE variant common information field if B54 and B55 in the common information field 1100 are both equal to ‘1’ and can interpret the common information field as an EHT common information field 1100 otherwise. In some embodiments, a recipient STA can use the bits and subfields mentioned above to parse the fields of the trigger frame appropriately.

In some embodiments, the common information version field 1130 is defined. In such embodiments, a UHR STA can identify the common information field 1110 of the trigger frame 1100 as a UHR common information field 1100 if the bits B54 and B55 in the common information field 1100 are both equal to ‘1.’ In at least one embodiment, the common information version field 1130 can be carried in a special user information field 1118 that includes an AID12 1122 having a value ‘2007.’ In other examples, the common information version field 1130 is carried in either the common information field 1100 or in a special user information field 1118 that includes an AID12 1122 having a value different than ‘2007’ (e.g., 2006 or 2008). In at least one embodiment, an HE STA can identify the common information field 1100 as an HE common information field 1100. In at least one embodiment, a non-AP EHT STA can interpret the common information field 1100 as an HE variant common information field 1100 if B54 and B55 in the common information field 1100 are equal to one ‘1.’ In some embodiments, legacy devices (e.g., legacy HE STAs and legacy EHT STAs) can interpret the UHR-variant common information field 1100 as a HE variant common information field 1100 and the solicited trigger-based PPDUs transmitted by them may be HE PPDUs. In one embodiment, the common information version field 1130 can also be referred to as a special user information version field.

In one embodiment, the more special user information field 1132 can be defined in the first Special user information field 1118 to indicate additional one or more follow up special user information fields 1118. For example, a bit in the special user information field 1118 can be set to one ‘1’ to indicate at least one follow up special user information field 1118 is present. In other embodiments, the bit in the special user information field 1118 can be set to zero ‘0’ to indicate there is not a follow up special user information field 1118. In some embodiments, a size of the follow up special user information fields 1118 is 40 bits excluding the trigger-dependent user information field 1134. That is, the size of 40 bits for the special user information fields 1118 excludes any trigger-dependent user information field 1134, if present, within the special user information field 1118. In at least one embodiment, trigger-dependent user information field 1134 may not be present in a follow up special user information field 1118. In at least one embodiment, the follow up special user information field 1118 may not be present in trigger frame variants that allow trigger-dependent user information fields 1134.

In one embodiment, legacy STAs (e.g., HE or EHT STAs) can interpret the more special user information field 1132 as user information fields addressed to other STAs. In one embodiment, the follow up special user information fields 1118 utilize a same AID12 value—e.g., each follow up STA includes an AID12 1112 field indicating a value ‘2007.’ In other embodiments, additional AID12s can be reserved to assign to the follow up special user information fields 1118—e.g., the AID12 value can be 2008, 2009, etc. In at least one embodiment, a number of special user information fields 1118 can be fixed based on a version of the common information field 1110 indicated in the common information version field 1130. In other embodiments, the number of special user information fields 1118 is based on a special user information count 1124 field indicating a number of additional special user information fields 1118 present. In one embodiment, the special user information count 1124 can be set to f(n), if there are n follow up special user information fields 1118. In some embodiments, f(n) can be any function—e.g., f(n)=n or f(n)=n−1, etc. In at least one embodiment, the more special user information 1132 or the special user information count 1124 can use some of the universal signal (U-SIG) disregard bits of a first special user information field 1118 (e.g., as depicted in FIG. 11C) or use some of the bits B22, B26, B53, or B56-63 of the common information field 1110. In one embodiment, the additional common information included in the special user information field 1118 can be parameters relevant to features such as non-primary channel access (NPCA), dynamic sub-band operations (DSO), dynamic power save (DPS) operations, co-existence indications, etc. In at least one embodiment, a follow up special user information field 1118 can include a control field, a presence bitmap field, or a subtype field to indicate its format and/or a type of additional information included within the respective follow up special use information field 1118.

FIG. 11B illustrates an example of an extended common information field. In one embodiment, FIG. 11B includes a trigger frame 1140. In one embodiment, trigger frame 1140 includes fields and subfield as described with reference to trigger frame 1100. For example, the trigger frame 1140 can include the frame control 1102, duration 1104, receiving station address 1106, transmitting station address 1108, common information field 1100, user information field 1112, padding 1114, and FCS 1116. In at least one embodiment, the user information field 1112 includes the special user information fields 1118 and user information fields 1120. In one embodiment, a special user information field 1118 of trigger frame 1140 can include an AID12 1142, a PHY version identifier 1144, UL bandwidth extension 1146, EHT spatial reuse 1 1148-a, EHT spatial reuse 2 1148-b, a universal signal (U-SIG) disregard and validate field 1150, common information version 1152, and trigger dependent user information 1154.

FIG. 11C illustrates an example of an extended common information field. In at least one embodiment, FIG. 11C includes a trigger frame 1160. In one embodiment, trigger frame 1160 includes fields and subfield as described with reference to trigger frame 1100. For example, the trigger frame 1160 can include the frame control 1102, duration 1104, receiving station address 1106, transmitting station address 1108, common information field 1100, user information field 1112, padding 1114, and FCS 1116. In at least one embodiment, the user information field 1112 includes the special user information fields 1118 and user information fields 1120. In one embodiment, a special user information field 1118 of trigger frame 1140 can include an AID12 1142, a PHY version identifier 1144, UL bandwidth extension 1146, EHT spatial reuse 1 1148-a, EHT spatial reuse 2 1148-b, a universal signal (U-SIG) disregard and validate field 1150, common information version 1152, and trigger dependent user information 1154. In some embodiments, the special user information field 1118 can include a UHR spatial reuse 1 and a UHR spatial reuse 2.

Accordingly, FIGS. 11A, 11B, 11C show alternative possible extended common information fields. In that, a special user information field 1118 can have any of the possible formats illustrated in FIGS. 11A, 11B, 11C, among others. In some embodiments, the common information field 1110 can include UHR parameters and be a UHR variant common information field. In such embodiments, the common information field 1110 can include fields or subfields of the EHT or HE variant common information fields—e.g., the UHR variant common information field can use a same encoding for some of the fields. For example, the common information field 1110 can include a trigger type, a UL length, more TF, CS required, LDPC extra symbol segment, AP transmit power, pre-FEC padding factor, PE disambiguity, and trigger dependent common information with the same encoding as described with reference to FIGS. 5A and 5B. In some embodiments, the common information field 1100 can include guard interval (GI) and HE/UHR-long training field (LFT) type and TXS mode, a number of HE/UHR LTF symbols, a UL spatial reuse, HE/UHR P160, a special user information field flag, distributed resource units (DRU)/radio remote unit (RRU) indications, an IFCS absent flag field (e.g., indicating whether the IFCS is present, where a zero ‘0’ indicate the IFCS is present and a one ‘1’ indicates the IFCS is not present), and a UHR reserved field. In at least one embodiment, the GI and HE/UHR-LTF type subfield is present if the trigger frame 1100 is not a MU-RTS trigger frame. In some embodiments, the GI and HE/UHR-LTF type subfield is present in a trigger frame that solicits a TB PPDU response and its encoding is defined according to FIG. 9-90b2 of P802.11bn. In one embodiment, the number of HE/UHR-LTF symbols subfield of the UHR variant common information field indicates a number of UHR-LTF symbols present in the UHR TB PPDU. In at least one embodiment, the special user information field flag is always set to one ‘1’ in a UHR variant common information field 1110 indicating that a special user information field is included in the trigger frame 1100 that contains the UHR variant common information field 1110. In one embodiment, the DRU/RRU indication subfield indicates whether distributed RU (DRU) or regular RU (RRU) transmission is solicited in each 80 MHz frequency subblock. In one embodiment, the format of the DRU/RRU indication is defined in FIG. 9-90c1 P802.11bn.

In other embodiments, all or a few of the special user information fields 1118 that carry common information can be present after an end of the user information list—e.g., after user information fields 1120. In such embodiments, the special user information fields 1118 at the end can carry for example, a frame check sequence that are used by some STAs that cannot receive the FCS 1116 present at the end of the trigger frame 1100. In some embodiments, the special user fields 1118 present at the end after the user information list can also carry a message integrity check field to check for the integrity of the trigger frames received.

In at least one embodiment, all or part of the extended common information (e.g., additional common information that could not be placed within the common information field 1110) that cannot fit within the special user information fields 1118 can be carried in new fields that are present at the end of the user information list. In some embodiments, the new field can begin with a 16-bit subfield set to all ones ‘1’ to let pre-UHR STAs interpret this as the beginning of the padding. In such examples, after the 16-bit subfield, the extended common information can be included in the trigger frame 1100.

In at least one embodiment, if the common information field 1110 or one of the special user information fields 1118 includes trigger dependent user information 1134 or trigger dependent user information 1154 (e.g., trigger dependent common information), part or all of the extended common information can be carried within those fields—e.g., within the trigger dependent user information fields 1134 or 1154.

In at least one embodiment, a UHR variant (e.g., or a variant in a subsequent Wi-Fi generation) of the common information field 1110 may not be backwards compatible. In such embodiments, the format of both the common information field 1110 and the special user information fields 1118 can be designed independently of HE and EHT variants of these fields—e.g., some of the bits can be reassigned or redefined. Additionally, in such embodiments, pre-UHR STAs may not be addressed by a trigger frame with a UHR common information field 1100.

In other embodiments, the UHR variant (e.g., or a variant in a subsequent Wi-Fi generation) of the common information field 1100 is backwards compatible. For example, the UHR variant of the common information field 1100 can be backwards compatible to HE STAs. In such embodiments, signaling in the common information field which is used by HE STAs may not be altered in the UHR variant common information field 1100. Instead, definitions of remaining bits of the common information field 1100 and/or the special user information fields 1118 can be changed-e.g., compared to an EHT variant of the same field. For example, to ensure backwards compatibility with the HE or the EHT variant common information field, a UHR AP can set bits B22, B26, B53, and B56 to zero ‘0’ and set bits B61 and B62 to one ‘1’ in the UHR common information field 1110. In at least one embodiment, the UHR variant, HE variant, and EHT variant common information fields can use a same encoding method for one or more fields or subfields. For example, the UHR variant common information field 1100, the HE variant common information field, and the EHT common information field can use the same encoding method for the trigger type, uplink (UL) length, more trigger frame (TF), CS required, low-density parity-check (LDPC) extra symbol segment, AP transmit (TX) power, Pre-Forward error correction (FEC) padding factor, packet extension (PE) disambiguity, and trigger dependent common information subfields—e.g., additional information about each of the subfields is described with respect to FIGS. 5A and 5B. Other fields or subfields can also have similar encoding. In at least one embodiment, when there is backwards compatibility, additional further signaling can also be included in follow-up special user information fields.

In one embodiment, an EHT STA may not be addressed by a trigger frame with a UHR variant common information field 1100. In other embodiments, however, the EHT STA can be addressed by a trigger frame with the UHR variant common information field 1100. In such examples, an AP can set bits B54 and B55 of the common information field to one ‘1’ such that the EHT STA can identify the trigger frame as a HE variant trigger frame. In other examples, the AP can set a bit B39 of the user information field 1112 addressed to the EHT STA to zero ‘0’ to indicate that the user information field 1112 is a HE variant user information field and thus the common information field 1110 should also be interpreted as the HE variant common information field by the EHT STA.

In at least one embodiment, the UHR variant (e.g., or a variant in a subsequent Wi-Fi generation) of the common information field 1100 can be backwards compatible with both HE and EHT STAs. That is, the fields defined for the HE and EHT common information field and special user information field may not be altered. In such embodiments, additional signaling for UHR devices or devices in a subsequent Wi-Fi generation can be indicated in reserved fields of the common information field 1110, in the special user information fields 1118, and in any follow-up special user information fields 1118. Accordingly, both the HE and EHT STAs can be addressed by the trigger frame with the UHR variant common information field 1110 (e.g., or addressed by a trigger frame for a subsequent Wi-Fi generation).

In at least one embodiment, a trigger frame recipient (e.g., a device receiving the trigger frame) belonging to a generation “X” (e.g., where “X” is the UHR generation or a subsequent Wi-Fi generation) can interpret the common information field 1110 based on the common information version 1130. For example, the trigger frame recipient belonging to generation “X” can interpret the common information field 1110 as the version indicated in the common information version 1130 if the common information version 1130 indicates a generation that is either “X” or precedes “X.” In some embodiments, if the indicated version in the common information field 1130 is beyond “X” (e.g., the device is receiving a trigger frame for a subsequent Wi-Fi generation), then a non-AP STA can interpret the common information field to be the HE variant common information field. In such embodiments, the non-AP STA can also ignore the one or more special user information fields 1118 present that carry the additional information. In other embodiments, if the indicated version in the common information field 1130 is beyond “X”, the non-AP STA can interpret the common information field to be an X-variant common information field. In additional embodiments, if the indicated version in the common information field 1130 is beyond “X”, there may be a bit present in the user information field 1112 indicating whether the common information field 1100 should be identified as the HE variant common information field or as the “X” variant common information field. In some embodiments, the recipient STA may use the above determination to parse the fields of the trigger frame appropriately. In at least one embodiment, the bit present in the user information field 1112 can indicate whether one or more of the special user information fields 1118 carrying additional common information should be ignored by the recipient STA.

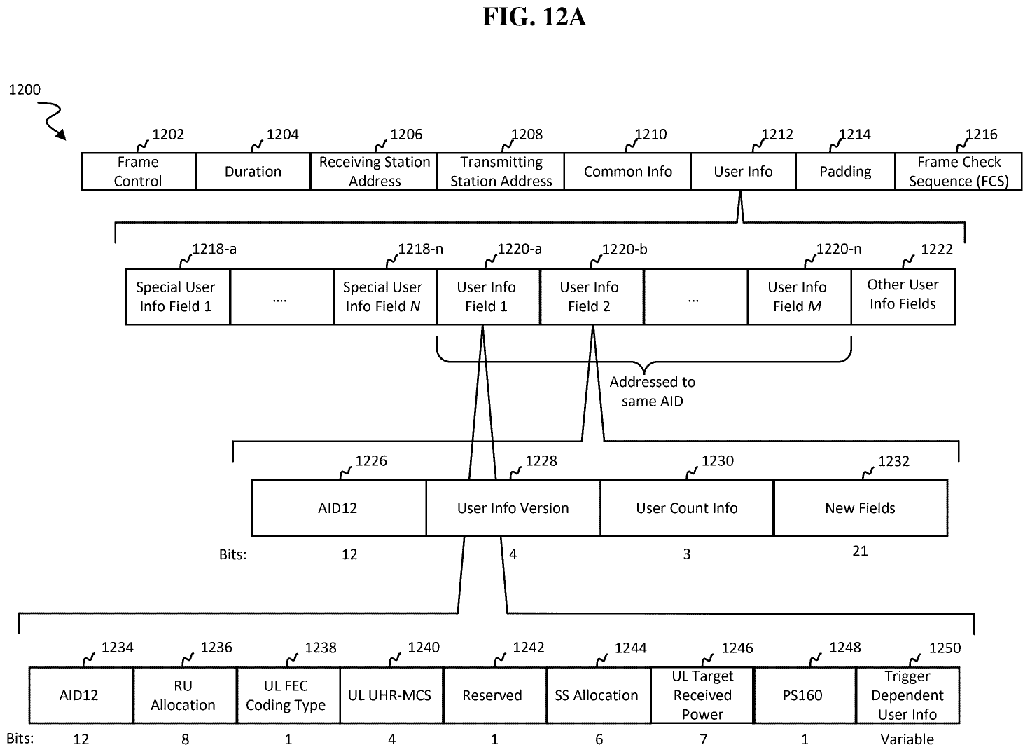

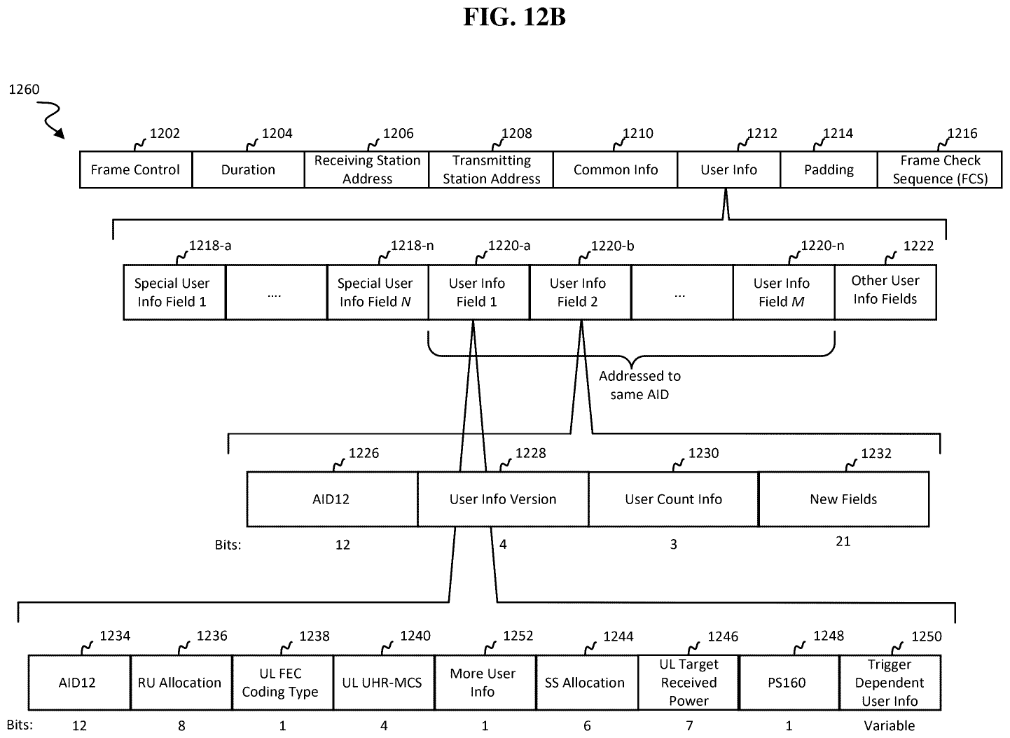

FIGS. 12A and 12B illustrate extended user information fields in accordance with embodiments herein. The format depicted in FIGS. 12A and 12B is for explanatory and illustration purposes. FIGS. 12A and 12B do not limit the scope of this disclosure to any particular implementation. Additionally, while some of the following embodiments discuss enhancements made to support 802.11bn or discuss ultra-high reliability (UHR) devices and specifications, the proposed solutions are not limited thereto. That is, the proposed solution can be implemented to be used for any future WiFi standard that relies on utilizing additional fields in the Trigger frames. Similarly, while some proposed embodiments discuss a trigger frame transmitted by an access point (AP) to a non-AP station (STA), the proposed solutions are not limited thereto. In some embodiments, the proposed solutions are appliable for triggers frames transmitted by a non-AP STA to the AP or from a first STA to a second STA. Further, although some embodiments discuss or propose specific fields for carrying indications, the indications can be indicated in other fields too or in a different format. Accordingly, such specific fields should be interpreted as examples and are not limitations on the embodiments or on the claims.

Referring to FIG. 12A, an extended user information field is shown. In one embodiment, FIG. 12A illustrates a trigger frame 1200. In such embodiments, the trigger frame 1200 can include a frame control 1202, a duration 1204, a receiving station address 1206, a transmitting station address 1208, common information 1210, user information 1212, padding 1214, and a frame check sequence (FCS) 1216. In one embodiment, the user information field 1212 can include one or more special user information fields 1218 and user information fields 1220—e.g., special user information field 1 1218-a, . . . , special user information field N 1218-n, user information field 1 1220-a, user information field 2 1220-b, . . . , and user information field N 1220-n. In some embodiments, the user information field 1212 can also include other user information fields 1222. In at least one embodiment, the user information fields 1220 are addressed to the same association ID (AID). In at least one embodiment, a user information field (e.g., user information field 2 1220-b) can include an association ID (AID12) 1226, user information version 1228, user count information 1230, and new fields 1232. In other embodiments, a user information field (e.g., user information field 1 1220-a) can include an association ID (e.g., AID12) 1234, resource unit (RU) allocation 1236, uplink (UL) forward error correction (FEC) coding type 1238, uplink UHR-modulation coding scheme (MCS) 1240, reserved field 1242, spatial stream (SS) allocation 1244, UL target received power 1246, PS160 1248, and trigger dependent user information 1250. Additional details regarding the subfields present in the user information field 1220-a are described with reference to FIGS. 7A and 7B. In one embodiment, the reserved field 1242 can be a 2xLDPC field—e.g., when the UL FEC coding type subfield 1238 is set to one ‘1’, the reserved field 1242 can be the 2xLDPC field indicating whether a nominal LDPC codeword length of 3888 is used. In one embodiment, the 2xLDPC can be set to zero ‘0’ to indicate the nominal LDPC codeword length of 648, 1296, or 1944 is used. In such embodiments, the 2xLDPC can be set to one ‘1’ to indicate the nominal LDPC codeword length of 3888 is used. In such examples, if the UL FEC coding type subfield 1238 is set to ‘0,’ the field is left as reserved 1242 and a bit within the subfield is set at one ‘1.’ In one embodiment, AID12 1234 of UHR variant user information field 1212 is encoded as defined in Tabel 9-46i of P802.11bn and has a value between 1 and 2006. In some embodiments, the RU allocation 1236 identifies a size and location of an RU or MRU along with the UL BW subfield in the common information field, the UL BW extension subfield in the special user information field, and the PS160 subfield 1248. In some embodiments, if the RU allocation 1236 indicates the assigned RU is located in an 80 MHz frequency subblock where the corresponding bit in the DRU/RRU indication subfield in the UHR variant common information field is set to one ‘1’, or located in more than 80 MHz frequency subblocks where the corresponding bits in the DRU/RRU indication subfield are all set to ls, the assigned RU is an RRU or an MRU. In at least one embodiment, the encoding of the RU allocation 1236 is based defined in Table 9-46m1, Table 9-46m2, and Table 9-46m3 in P802.11bn. In at least one embodiment, the UL FEC coding type 1238 indicates the code type of the solicited UHR TB PPDU. In at least one embodiment, the UL FEC coding type 1238 is set to zero ‘0’ to indicate block check character (BCC) and set to one ‘1’ to indicate LDPC. In at least one embodiment, the UL UHR-MCS 1240 indicates the UHR-MCS of the solicited UHR TB PPDU. In some embodiments, the UL UHR-MCS 1240 encoding is defined in 38.3.12 of P802.11bn. In at least one embodiment, if the RU allocation 1236 indicates the assigned RU is located in an 80 MHz frequency subblock where the corresponding bit in the DRU/RRU indication subfield in the UHR variant common information field 1210 is set to one ‘1’, or located in more than one 80 MHz frequency subblocks where the corresponding bits in the DRU/RRU indication subfield in the UHR variant common information field 1210 are set to all 1s, the SS allocation 1244 associated with an RRU indicates the spatial streams of the solicited UHR TB PDDU and the format is defined in FIG. 9-90j2 of P802.11bn—e.g., the SS allocation 1244 can indicate a starting spatial stream and a number of spatial streams. In some embodiments, the starting spatial streams indicates the starting spatial stream and is set to the starting spatial stream minus 1 with a maximum value of 7 for the starting spatial stream subfield. In some embodiments, the starting spatial stream subfield is set to 0 if the corresponding RU or MRU is not allocated for MU-MIMO. In some embodiments, the number of spatial streams subfield indicates the number of spatial streams, and is set to the number of spatial streams minus 1 with a maximum value of 3.

In some examples, if the RU allocation 1236 indicates the assigned RU is located in an 80 MHz frequency subblock where the corresponding bit in the DRU/RRU indication subfield in the UHR variant common information field 1110 associated with a DRU indicates the DRU distribution bandwidth and spatial streams of the solicited UHR TB PPDu and the format is defined in FIG. 9-90j3 of P802.11bn. In at least one embodiment, the DRU distribution BW subfield indicates the distribution bandwidth of the assigned DRU and is encoded with a 0 for a distribution width of 20 MHz, 1 for a distribution width of 40 MHz, 2 for a distribution width of 80 MHZ, and a 3 for a distribution bandwidth of 160 MHz. In some examples, the number of spatial streams subfield indicates the number of spatial streams minus 1 with a maximum value of 1.

In at least one embodiment, the UL target received power 1246 indicates the expected receive power signal power, measured at the AP's antenna connector and averaged over the antennas, for the UHR portion of the UHR TB PPDU transmitted on the assigned RU and is defined in table 9-46k of P802.11bn. In some embodiments, if the size of RU or MRU is smaller than or equal to 2×996-tones, then the PS160 1248 subfield is set to 0 to indicate that the RU or MRU allocation applies to the primary 160 MHz channel and set to 1 to indicate that the RU or MRu allocation applies to the secondary 160 MHz channel. In other embodiments, the PS160 1248 indicates the RU or MRU index along with the RU allocation 1236. In some embodiments, the PS160 1248 is set based on Table 9-461 of P802.11bn.

In at least one embodiment, the trigger frame 1200 can include a new version or format (e.g., a UHR format or subsequent Wi-Fi generation format) of the user information field 1212. In one embodiment, a size of the user information field 1212 is 40 bits. In some embodiments, the 40 bit size may refer to a size of the user information field 1212 excluding any trigger-dependent user information fields 1250, if present, within the user information field 1220. In one embodiment, the UHR version (e.g., or subsequent Wi-Fi version) of the user information field 1212 can include all of or a portion of the subfields of an EHT version user information field as described with reference to FIG. 7B—e.g., the user information field 1220-a can include subfields that are used in the EHT user information 750. In at least one embodiment, a user information field 1212 addressed to a UHR STA can have the UHR version/format of the user information field 1212—e.g., a UHR AP can address the user information 1212 to the UHR STA and in such embodiments, the user information 1212 can have the UHR format. In some examples, the user information 1212 can include a user information version subfield 1228 to indicate a version of the user information 1212. In other embodiments, a bit b25 of an EHT user information field (e.g., the reserved field 775 as described with reference to FIG. 7B) can be set to a value to indicate that the user information field is a UHR variant.

In at least one embodiment, the version of the user information field 1212 can be determined by the receiving STA. For example, the receiving STA can determine the version of the user information 1212 based on at least one of the following, the version of the common information field 1210 (e.g., as indicated in a special user information field 1118 as described with reference to FIGS. 11A, 11B, and 11C), signaling carried in either the common information field 1220 or the special user information field 1218, signaling carried within the user information field 1212, the generation of the receiving STA—e.g., based on whether the STA is a HE STA, EHT STA, UHR STA, etc. For example, a user information field 1212 addressed to a non-AP STA can be one of an HE variant, an EHT variant, or UHR variant. In such embodiments, the user information field 1212 as an HE variant addressed to a non-AP EHT or a UHR STA if a bit (e.g., bit B39) of the user information field 1212 is set to zero ‘0’ and a bit (e.g., bit B54) of the common information field 1210 is set to one ‘1’ in the trigger frame 1260. In such examples, the user information field 1212 is an EHT variant or a UHR variant if the bit B39 is not zero ‘0’ or the B54 is not one ‘1.’ In some embodiments, whether the user information field 1212 is an EHT variant or an UHR variant depends on the physical layer (PHY) version identifier subfield (e.g., PHY version identifier 1144 or common information version 1130 as described with reference to FIG. 11). For example, if the user information field 1212 is an EHT variant, the PHY version identifier of a special user information field 1218 is set to zero ‘0.’ In such embodiments, if the user information field 1212 is a UHR variant, the PHY version identifier of the special user information field 1218 is set to one ‘1.’ In at least one embodiment, a bit (e.g., bit b39 or reserved field 740 as described with reference to FIG. 7A) of an HE variant user information field is reserved for a non-EHT HE STA. In some embodiments, an EHT AP or a UHR AP sets the bit B39 to zero ‘0’ for an HE variant user information field. In at least one embodiment, the bit B39 is the PS160 subfield 1248 for an EHT or UHR variant user information field. Accordingly, a UHR STA can interpret the user information field 1212 addressed to it as a UHR, EHT, or a HE variant user information field 1212 if the common information version is UHR, EHT, or HE variant respectively—e.g., the UHR STA interprets the user information field 1212 addressed to it based on the indicated common information version within a special user information field 1218 (e.g., as described with reference common information version 1130 in FIG. 11A). In at least one embodiment, the UHR STA can interpret the user information field 1212 addressed to it as a UHR variant user information field 1212 if the common information version indicated in the special user information is of a future generation beyond UHR-e.g., associated with a device in a subsequent Wi-Fi generation. In other examples, the UHR STA can interpret the user information field 1212 addressed to it as an HE variant user information field if the common information version indicated is of a future generation—e.g., the UHR STA can interpret the user information field 1212 as a UHR variant or a HE variant based on the configuration of the UHR STA if the common information version indicated is of a future generation.

In another embodiment, if the bit B39 of the user information field 1212 is set to one ‘1’, the user information field 1212 can be interpreted as a minimum of the non-AP STA generation or the indicated common information version of the trigger frame—e.g., the user information field 1212 is identified as the older generation between the non-AP STA generation and the indicated common information version of the trigger frame. In such embodiments, if the bit B39 of the user information field 1212 is set to zero ‘0,’ the user information field 1212 can be identified as the HE variant user information field. In some embodiments, a size of some of the existing fields of the UHR variant (e.g., or a variant in a subsequent Wi-Fi generation) user information field 1212 can be reduced to accommodate new fields corresponding to new features. In at least one embodiment, the new features can be accommodated with additional subfields carried in one or more follow up user information fields 1220 that are included—e.g., the additional information for the new features can be carried in the follow up user information fields 1220. In some embodiments the follow-up user information fields 1220 can be of length 40 bits as illustrated with example to user information field 2 1220-b. In some embodiments, the size 40 bits excludes any trigger-dependent user information fields 1250, if present, within the user information field 1220. In some embodiments, the trigger-dependent user information fields 1250 may not be present in a follow-up user information field 1220. In some embodiments, the follow up user information field 1220 may not be present in trigger frame variants that allow trigger-dependent user information fields 1250. In some embodiments, the follow up user information fields 1220 are included immediately after the first user information field 1220 addressed to the UHR STA—e.g., the follow up user information field 2 1220-b—user information field N 1220-n are included immediately after user information field 1 1220-a. For example, FIG. 12A illustrates M—1 follow up user information fields 1220 that are included for after the first user information field 1220-a addressed to the same STA—e.g., having the same AID.

FIG. 12B illustrates an example of an extended user information field. In one embodiment, FIG. 12B includes a trigger frame 1260. In one embodiment, trigger frame 1260 includes fields and subfield as described with reference to trigger frame 1200. For example, the trigger frame 1260 can include the frame control 1202, duration 1204, receiving station address 1206, transmitting station address 1208, common information field 1210, user information field 1212, padding 1214, and FCS 1216. In at least one embodiment, the user information field 1212 includes one or more special user information fields 1218 and one or more user information fields 1220. In some embodiments, the user information field 1212 can also include other user information fields 1222. In one embodiment, a user information field 1220 (e.g., user information field 2 1220-b) of trigger frame 1260 can include an AID12 1226, a user information version 1228, a user count information 1230, and new fields 1232. In at least one embodiment, the user information field 1220 (e.g., user information field 1 1220-a) can include an association ID (e.g., AID12) 1234, resource unit (RU) allocation 1236, uplink (UL) forward error correction (FEC) coding type 1238, uplink UHR-modulation coding scheme (MCS) 1240, more user information 1252, spatial stream (SS) allocation 1244, UL target received power 1246, PS160 1248, and trigger dependent user information 1250.

In at least one embodiment, the more user information field 1252 is defined in the user information field 1 1220-a to indicate that there are one or more follow up user information fields 1220 present addressed to the same receiving STA as the STA that receives user information field 1220-a. In one embodiment, the more user information field 1252 can utilize a bit (e.g., bit B25) of the EHT user information field as illustrated in FIG. 12B (with reference to FIG. 7B). In at least one embodiment, the follow up user information fields 1220 (e.g., user information field 2 1220-b to user information field N 1220-n) can use the same AID12 field 1226 that address the recipient STA—e.g., the follow up user information 1220 can be addressed to the same STA as the first user information field 1 1220-a. In some embodiments, the number of user information fields 1220 present is fixed and based on a version or format of the user information field 1212 or based on the STA's version capability.

In some embodiments, the user information field 1220 can include a user information count 1230 indicating a number of additional user information fields 1220 present with the same AID12—e.g., indicating a number of follow up user information fields 1220. In one embodiment, the user information count 1230 can be set to f(n), if there are n follow up user information fields 1230 that are addressed to the same receiving STA. In some embodiments, f(n) can be any function—e.g., f(n)=n or f(n)=n−1, etc.

In at least one embodiment, if a user information field 1220 includes the trigger dependent user information 1250 subfield, all or part of the additional user information can be carried within the trigger dependent user information field 1250.

In at least one embodiment, either of the extended common information field (e.g., common information field 1110 as described with reference to FIGS. 11A, 11B, and 11C) or the extended user information field (e.g., user information field 1212 as described with reference to FIGS. 12A and 12B) can carry new signaling or indications defined in 802.11bn or beyond. It should be noted that the following examples are not exhaustive or limiting. They are merely shown for illustrative purposes. In some embodiments, the extended common information field 1110 or the extended user information field 1212 can include an indication of the purpose of the trigger frame. For example, the purpose indicated can be for initiating multi-AP coordination, for dynamic sub-band allocations, initiating non-primary channel access, checking for coexistence issues, etc. In some examples, the extended common information field 1110 or the extended user information field 1212 can include parameters for multi-AP coordination. In such embodiments, the parameters could include indications of the trigger frame being used for multi-AP coordination, the type of multi-AP coordination being performed (e.g., a coordinated time division multiple access (TDMA), a coordinated orthogonal frequency division multiple access (OFDMA), coordinated restricted target wake time (RTWT), coordinated spatial reuse, etc.), shared resources for the coordination, allowed transmit power levels, transmit power used, allowed interference limits, etc. In some embodiments, the extended common information field 1110 or the extended user information field 1212 can include parameters for coordination with peer-to-peer (P2P) stations such as a type of P2P coordination being performed (e.g., coordinated TDMA, coordinated OFDMA, coordinated RTWT, coordinated spatial reuse, etc.), shared resources for the coordination, allowed transmit power levels, transmit power used, allowed interference limits, etc. In other embodiments, the extended common information field 1110 or the extended user information field 1212 can include parameters for dynamic sub-band operations such as an indication of resource pre-allocation, an indication of primary channels to be monitored after sub-band switch, an indication of whether a response to trigger frames is solicited, an indication of an expected start time of a transmission to a STA, an indication of a switch back time to an STA, etc. In some examples, the extended common information field 1110 or the extended user information field 1212 can include parameters for non-primary channel access such as an indication of an energy detection threshold to be used by the STAs for sending a response, an indication of a switch back time to the primary channel, an indication of the duration of persistence or channel access on the non-primary channel, etc. In at least one embodiment, the extended common information field 1110 or the extended user information field 1212 can include an indication of a type of medium access control (MAC) frame solicited in response to the trigger frame and/or the information sought in the response. For example, a type of PPDUs can be buffer status report (BSR) frames, bandwidth query (BQR) frames, block acknowledgement (BA) frames, or multi-STA BA frames. In some examples, the information sought in the response can be coexistence, unavailability, or quality of service (QOS) requirement information. In at least one embodiment, the extended common information field 1110 or the extended user information field 1212 can include parameters for distributed resource unit (dRU) allocations to one or more addressed STAs such as indications for sub-bands where dRU allocations are applicable, etc. In some embodiments, the extended common information field 1110 or the extended user information field 1212 can include coexistence requirements of transmitting STAs and include periods of unavailability.

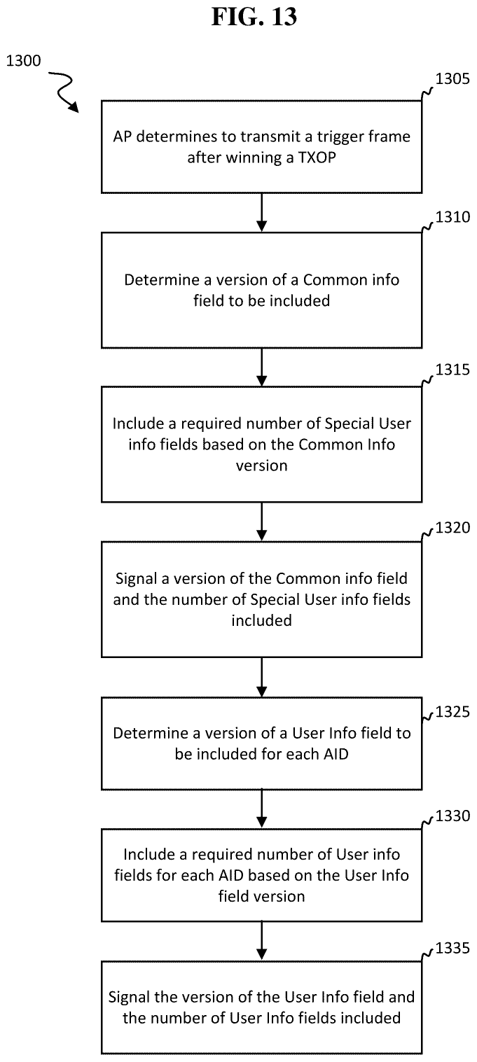

FIG. 13 shows an example process 1300 for using an expanded common and user information field in trigger frames in accordance with an embodiment accordance with an embodiment. For explanatory and illustration purposes, the process 1300 may be performed by an AP. In other embodiments, the process described herein can be performed by an STA. Although one or more operations are described or shown in a particular sequential order, in other embodiments the operations may be rearranged in a different order, which may include performance of multiple operations in at least partially overlapping time periods.

Referring to FIG. 13, the process 1300 may begin in operation 1305. In operation 1305, an AP determines to transmit a trigger frame after winning a transmit opportunity (TXOP)—e.g., the AP can obtain a TXOP on a wireless channel for a first duration. In such embodiments, during the TXOP, the AP can determine to transmit a trigger frame to solicit a response from one or more STAs.

In operation 1310, the first AP determines a version of the common information field to be included in the trigger frame. As described with reference to FIGS. 11-12, the trigger frame can include a common information field associated with an HE variant, an EHT variant, a UHR variant, or a subsequent Wi-Fi generation variant. In such embodiments, the AP can encode the common information field to indicate the type of trigger frame it is (e.g. or indicates how a receiving STA should interpret the trigger frame). In one embodiment, the AP can determine to include a HE variant trigger frame and set bits B54 and B55 both equal to ‘1’ in the common information field. In other embodiments, the AP can determine to include a EHT variant or a UHR variant. In such embodiments, the AP can set B54 or B55 to not equal to one ‘1’. Additionally, the AP can also encode a physical layer (PHY) version identifier (e.g., or common information version 1130) in a special user information field to indicate the variant of the common information field. In one embodiment, the AP can encode a zero ‘0’ in the PHY version identifier to indicate the EHT variant and a one ‘1’ in the PHY version identifier to indicate the UHR variant. In at least one embodiment, values 2-7 are reserved for the PHY version identifier. Accordingly, future Wi-Fi generations can be assigned a new PHY version identifier value and be identified accordingly. In an alternative embodiment, the AP can set both bits B54 and B55 as ‘1’ and a UHR STA can identify the trigger frame as UHR variant. In such embodiments, a HE STA can identify the common information field as a HE common information field and a non-AP EHT STA can identify the common information field as an HE variant since B54 and B55 are set to 1. In this embodiment, a trigger frame recipient belonging to a generation “X” (e.g., where ‘X’ is UHR or beyond) can interpret the common information field as the version indicated in the PHY version identifier if the PHY version identifier indicates a generation that is X or precedes X. In such examples, if the indicated generation is beyond “X,” the common information field is interpretated as a HE variant. For example, if a UHR device decodes a value ‘1’ for the PHY version identifier, the UHR device can interpret the common information field as a UHR variant. In such embodiments, if the UHR device decodes the value ‘2’ or greater for the PHY version identifier, the UHR device can interpret the common information field as a HE variant.

In operation 1315, the AP includes a required number of special user information fields based on the common information version. As described with reference to FIGS. 11A-C, in some embodiments, there can be a predefined number of special user information fields. In other embodiments, the AP can determine a number of special user information fields to include based on an amount of information to be transmitted.

In operation 1320, the AP signals the version of the common information field, and the number of special user information fields included. In some embodiments, the AP can signal the version of the common information field by setting the bits b54, b55, and the PHY version identifier as described above. In at least one embodiment, the AP can signal the special user information fields included in a special user information count or a more special user information subfield.

In operation 1325, the AP can determine a version of the user information field to be included for each AID. As described with reference to FIGS. 12, the trigger frame can include a user information field associated with an HE variant, an EHT variant, a UHR variant, or a subsequent Wi-Fi generation variant. In such embodiments, the AP can encode the user information field to indicate the type or version of the user information field—e.g. encode the field to indicate how a receiving STA should interpret the trigger frame.

In operation 1330, the AP includes a required number of user information fields for each AID based on the user information version field. As described with reference to FIGS. 12A-B, in some embodiments, there can be a predefined number of user information fields. In other embodiments, the AP can determine a number of user information fields to include based on an amount of information to be transmitted.

In operation 1335, the AP can signal the user information field and the number of user information fields to be included. In some embodiments, the AP can signal the user information field based on the version of the common information field, signaling carried in the common information field or the special user information field, signaling carried within the user information field, or the generation of the receiving STA. In one embodiment, the user information field can be an HE variant if Bit B39 of the user information field is set to 0 and bit b54 of the common information field is set to 1, otherwise it is an EHT or UHR variant. In such embodiments, the AP can utilize the PHY version identifier to signal whether the user information field is the EHT or UHR variant as described above.

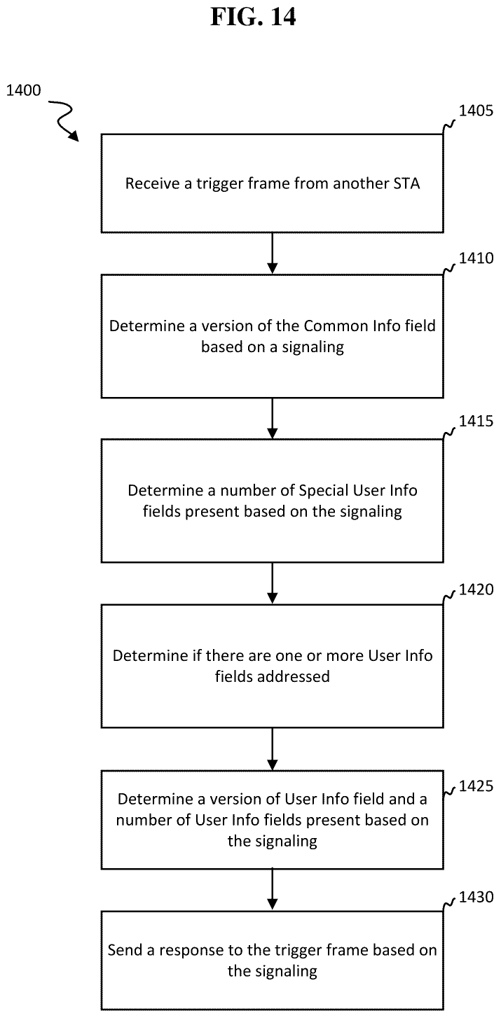

FIG. 14 shows an example process 1400 for using an expanded common and user information field in trigger frames in accordance with an embodiment accordance with an embodiment. For explanatory and illustration purposes, the process 1400 may be performed by an STA. In other embodiments, the process described herein can be performed by an AP. Although one or more operations are described or shown in a particular sequential order, in other embodiments the operations may be rearranged in a different order, which may include performance of multiple operations in at least partially overlapping time periods.

Referring to FIG. 14, the process 1400 may begin in operation 1405. In operation 1405, a STA receives a trigger frame from another STA or an AP.

In operation 1410, the STA can determine a version of the common information field based on a signaling included in the trigger frame. For example, the STA can determine the version of the common information field based on determining a value for bits 54 and bits 55 of the common information field and the value of the PHY version identifier. In one embodiment, the STA can determine the common information field is a HE variant if bits B54 and B55 are both equal to 1. In other embodiments, the STA can determine the common information field is an EHT variant if bits B54 and B55 are not equal to 1 (e.g. one of bit B54 or B55 is not 1) and the PHY version identifier is zero ‘0.’ In other embodiments, the STA can determine the common information field is UHR variant if bits B54 and B55 are not equal to 1 and the PHY version identifier is one ‘1.’

In operation 1415, the STA determines a number of special user information fields present based on the signaling. For example, the STA can decode either the special user information count or the more special user information as described with reference to FIG. 11 to determine the number of follow up special user information fields.

In operation 1425, the STA can determine if there are one or more user information fields present. In some embodiments, the STA can determine if there are one or more user information fields based on signaling received after the special user information or based on an AID value of a received field.

In operation 1430, the STA determines a version of the user information field and a number of user information fields present based on the signaling. In some embodiments, the STA can determine the version of the user information field based on the version of the common information field, signaling carried in the common information field or the special user information field, signaling carried within the user information field, or the generation of the receiving STA. For example, the STA can decode bit B54 of the common information field, bit 39 of the user information field, and the PHY version identifier of the special user information field to determine the version of the user information field. In one embodiment, the STA can determine the user information field is an HE variant if bit B39 of the user information field is set to 0 and bit 54 of the common information field is set to 1, otherwise the user information field can be the EHT or UHR variant. To determine between the two, the STA can decode the PHY version identifier. In one embodiment, the STA can determine the user information field is a the EHT variant when the PHY version identifier is set to 0 and determine the user information field is the UHR variant when the PHY version identifier is set to 1. In some embodiments, an STA belonging to a future generation of Wi-Fi can determine the user information version based on the PHY version identifier—e.g., values 2-7 of the PHY version identifier are reserved for future generations.

In operation 1435, the STA can transmit a response to the trigger frame based on the signaling. That is, the STA can transmit a response back to the other STA or to an AP with the information requested in the trigger frame received.

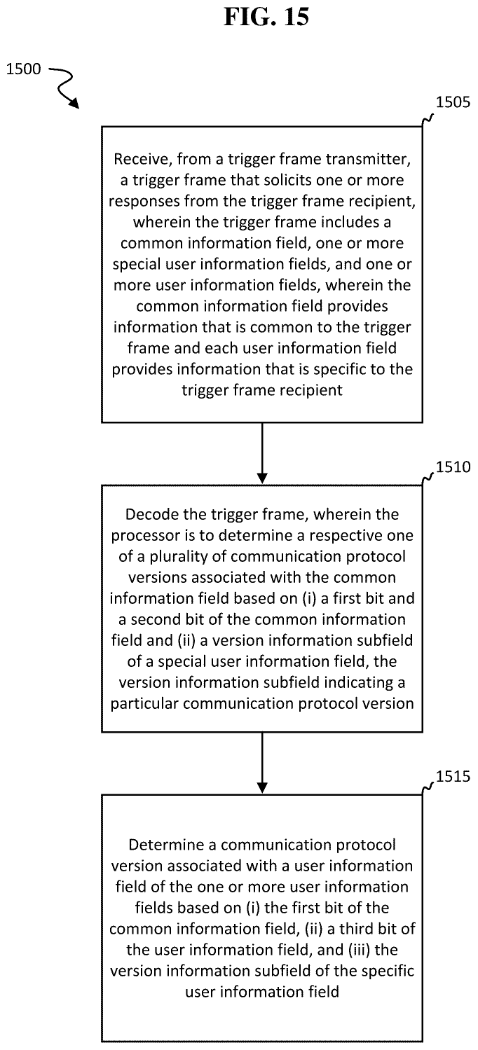

FIG. 15 shows an example process 1500 for using an expanded common and user information field in trigger frames in accordance with an embodiment accordance with an embodiment. For explanatory and illustration purposes, the process 1500 may be performed by a trigger frame recipient (e.g., an AP or an STA). Although one or more operations are described or shown in a particular sequential order, in other embodiments the operations may be rearranged in a different order, which may include performance of multiple operations in at least partially overlapping time periods.

Referring to FIG. 15, the process 1500 may begin in operation 1505. In operation 1505, the trigger frame recipient can receive a trigger frame from a trigger frame transmitter. In one embodiment, the trigger frame solicits one or more responses from the trigger frame recipient. In at least one embodiment, the trigger frame includes a common information field, one or more special user information fields, and one or more user information fields, where the common information field and the one or more special user information fields provide information that is common to the trigger frame and each user information field provides information that is specific to the trigger frame recipient identified by the user information field.

At operation 1510, the trigger frame recipient can decode the trigger frame, where the processor of the trigger frame recipient is to determine a respective one of a plurality of communication protocol versions associated with the common information field based on (i) a first bit and a second bit of the common information field and (ii) a version information subfield of a special user information field, the version information subfield indicating a particular communication protocol version. That is, the trigger frame is generated to solicit one or more responses from one or more trigger frame recipients, where each of the one or more trigger frame recipients are associated with a respective one of a plurality of communication protocol version—e.g., the trigger frame recipient could belong be a HE, EHT, or UHR device implementing an HE, EHT, or UHR communication protocol respectively. In some embodiments, variant, format version, and communication protocol refer to the same thing. That is, an HE, EHT, or UHR communication protocol can refer to an HE variant, EHT variant, or UHR variant information field, respectively (e.g., a HE variant common information field, a HE variant user information field, a HE variant special user information field, an EHT variant common information field, an EHT variant user information field, an EHT variant special user information field, a UHR variant common information field, a UHR variant user information field, a UHR variant special user information field, or a subsequent Wi-Fi variant user, common, or special user information field.) Accordingly, each trigger frame recipient can receive the trigger frame and determine the communication protocol associated with the common information field or the user information field.

In at least one embodiment, the processor can decode the trigger frame and determine the first bit and the second bit of the common information field indicate whether the common information field is associated with a first communication protocol. In one embodiment, the first communication protocol is an HE communication protocol. In such embodiments, the first bit can refer to bit B54 and the second bit can refer to B55. In some embodiments, the trigger frame recipient interprets the common information field as using an HE communication protocol if the first and second bit are equal to 1. In other embodiments, the first communication protocol can be a UHR communication protocol. In such embodiments, if bits B54 and B55 in the common information field are both set to 1, it is identified as a UHR variant. In such embodiments, a EHT STA can identify the trigger frame as HE variant. That is, the trigger frame recipient can decode the version information subfield and determine a first communication protocol associated with the version information subfield, where the trigger frame recipient determines the first communication protocol based on a second communication protocol of the trigger frame recipient. In some embodiments, this can enable a trigger frame recipient belonging to a generation “X” (e.g., where “X” is UHR or beyond) to interpret the common information field as the version indicated in the version information subfield if the common information indicates a version that is either “X” or precedes “X.” Accordingly, if the common information field indicates something beyond “X,” the STA interprets the common information as a HE communication protocol.

In some embodiments, the version information subfield indicates whether the common information field is associated with a second communication protocol or a third communication protocol—e.g., the version information subfield indicates whether the common information field is a EHT communication protocol or a UHR communication protocol. In other embodiments, the version information subfield indicates the common information field is associated with a second communication protocol of the plurality of communication protocol versions different than the first communication protocol. That is, the version information subfield can indicate a value from zero to seven (0-7) as described with reference to the common information version 1130. In such embodiments, the trigger frame recipient can utilize the bits B54 and B55 to determine if it is an HE communication protocol and then identify what particular communication protocol it is based on the version information subfield if it is not the HE communication protocol.

In operation 1515, the trigger frame recipient is to determine a communication protocol version associated with the user information field based on at least one of (i) the first bit of the common information field, (ii) a third bit of the user information field, and (iii) the version information subfield of the specific user information field. That is, the user information field that is addressed to the trigger frame recipient is one of an HE communication protocol, an EHT communication protocol, or a UHR communication protocol. In at least one embodiment, the trigger frame recipient can further determine the communication protocol based on a version information subfield of the user information field. That is, in some embodiments, the user information field can include a user information version subfield (e.g., user info version 1228 as described with reference to FIG. 12A). In such embodiments, the AP can indicate a communication protocol (e.g., variant) of the user information field in the user information version subfield. For example, the AP can encode a zero ‘0’ to the user information version subfield to indicate an EHT communication protocol (e.g., variant) user information field and encode a one ‘1’ to the user information version subfield to indicate a UHR communication protocol. In some embodiments, the AP can encode a different value to the user information version subfield to indicate a communication protocol beyond the UHR Wi-Fi generation (e.g., value between 2 and 7).

In one embodiment, the first bit of the common information field and the third bit of the user information field indicate whether the user information is associated with a first communication protocol. In such embodiments, the version information subfield indicates whether the user information field is associated with a second communication protocol or a third communication protocol. For example, in at least one embodiment, the User Information field is an HE communication protocol if bit B39 of the User Info field is set to 0 and bit B54 of the Common Info field is set to 1 in the trigger frame; otherwise, it is an EHT or UHR communication protocol, depending on the version information subfield in the Special User Info field. That is, it is an EHT communication protocol if the version information subfield in the Special User Info field is set to 0, or a UHR communication protocol if the version information subfield in the Special User Info field is set to 1.

In at least one embodiment, the version information subfield indicates the user information field is associated with a second communication protocol of the plurality of communication protocol versions different than the first communication protocol. That is, the version information subfield can indicate a value from zero to seven (0-7) as described with reference to the common information version 1130. In such embodiments, the trigger frame recipient can utilize the bits B54 of the common information field and B39 of the user information field to determine if it is an HE communication protocol and then identify what particular communication protocol it is based on the version information subfield if it is not the HE communication protocol.

In at least one embodiment, the plurality of communication protocols include a first communication protocol, a second communication protocol, and a third communication protocol, and in a case that the common information field is associated with the third communication protocol, a plurality of bits in the common information field have predetermined values to provide backwards compatibility with the first communication protocol or the second communication protocol. That is, for backward compatibility with the HE or EHT communication protocol Common Info field, a UHR AP can set bits B22, B26, B53, and B63 of the common information field to 0 and sets B61-B62 to 1 in the UHR communication protocol Common Info field.

In at least one embodiment, the special user information field includes an indication of at least one of the presence of one or more follow up special user information fields that are present after the special user information field or the number of follow up special user information fields present after the special user information field. In at least one embodiment, at least one follow up special user information field (e.g., or each special user information field) is a user information field that carries information common for multiple receiving STAs.

In some examples, an information field of the one or more user information fields includes an indication of at least one of the presence of one or more follow up user information fields that are present after the user information field and are addressed to the same trigger frame recipient or the number of follow up user information fields that are addressed to the same trigger frame recipient and are present after the user information field. In at least one embodiment, the user information field includes a user information version subfield indicating the particular communication protocol version.

In one embodiment, the user information field is associated with a first association identification and the one or more follow up user information fields are associated with a second association identification. For example, a second user information field of the one or more user information fields includes the second association identification. That is, as described with reference to FIGS. 11A, 11B, and 11C, the common information can be carried in new special user information fields or user information fields that have an AID12 different than 2007—e.g., 2006 or 2008). In at least one embodiment, a special user information field is a user information field that carries common information applicable to more than one user. In one example, the special user information field is a user information field having an AID12 value 2007 and if the special user information field flag in an EHT or UHR variant common information field is set to 0. In other embodiments, the special user information field could have a value different than AID12 2007. That is, the first and second user information fields described having different association identifications can be examples of a first and second special user information fields having different association identifications. Accordingly, the trigger frame transmitter could transmit a user information field or special user information field having a different AID12 value to indicate one of a non-access operation parameter, a co-existence indication, or an intermediate frame check sequence.

In at least one embodiment, the second user information fields refrain from including trigger dependent user information. That is, in some examples, the follow up user information fields can be 40 bits with no trigger dependent user information field present in the respective follow up user information field. In other embodiments, the second user information field can be an example of a special user information field. In such embodiments, the special user information field can refrain from including trigger dependent user information—e.g., a follow up special user information field can be exactly 40 bits and not include trigger dependent user information.

In one embodiment, the common information field, the user information field, a follow-up user information field, the special user information field, or the follow up special user information fields includes parameters associated with a non-primary channel access operation, a co-existence indication, or an intermediate frame check sequence (IFCS). That is, the additional common information or user information carried in the new fields in the common information field, or the special user information field, or the user information field carry signaling for at least one of the following operations: initiating multi-AP coordination, parameters for DSO operations, parameters for an NPCA operation, parameters for peer-to-peer (P2P) station coordination, indications of MAC frames solicited, parameters for distributed resource units (dRU), co-existence indications, and intermediate frame check sequences as described with reference to FIG. 12B. For example, a special user information field (e.g., or common information field or user information field) can include an NPCA primary channel indication subfield that indicates whether the trigger frame is transmitted on the NPCA primary channel. In one embodiment, if the PHY version identifier subfield is set to one ‘1’, the NPCA primary channel indication field is set to one ‘1’ if the trigger frame is transmitted by an NPCA STA that has switched to the NPCA primary channel and is set to zero ‘0’ otherwise. In one embodiment, if the PHY version identifier is set to zero ‘0’, the NPCA primary channel indication subfield is reserved. In other embodiments, the special user information field, the common information field, or the user information field described herein can carry any parameter corresponding to an operation initiated by the trigger frame.

By using the trigger frame with expanded common and user information fields, the AP or STA can indicate both a variant or communication protocol version of the trigger frame as well as transmit additional information associated with an operation.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of”' does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A trigger frame recipient in a wireless network, comprising:
a memory; and
a processor coupled to the memory, the processor configured to cause:
receive, from a trigger frame transmitter, a trigger frame that solicits one or more responses from the trigger frame recipient, wherein the trigger frame includes a common information field, one or more special user information fields, and one or more user information fields, wherein the common information field and the one or more special user information fields provide information that is common to one or more trigger frame recipients of the trigger frame and each user information field provides information that is specific to the trigger frame recipient identified by the user information field; and
decode the trigger frame, wherein the processor is configured to determine a communication protocol version associated with the common information field based on (i) a first bit and a second bit of the common information field and (ii) a version information subfield of a special user information field, the version information subfield indicating a particular communication protocol version.

2. The trigger frame recipient of claim 1, wherein the first bit and the second bit of the common information field indicate whether the common information field is associated with a first communication protocol.

3. The trigger frame recipient of claim 2, wherein the version information subfield indicates whether the common information field is associated with a second communication protocol or a third communication protocol.

4. The trigger frame recipient of claim 2, wherein the version information subfield indicates the common information field is associated with a second communication protocol of the plurality of communication protocol versions different than the first communication protocol.

5. The trigger frame recipient of claim 1, wherein the processor is further configured to:
determine a communication protocol version associated with a user information field of the one or more user information fields based on at least one of (i) the first bit of the common information field, (ii) a third bit of the user information field, and (iii) the version information subfield of the specific user information field.

6. The trigger frame recipient of claim 5, wherein the first bit of the common information field and the third bit of the user information field indicate whether the user information is associated with a first communication protocol.

7. The trigger frame recipient of claim 6, wherein the version information subfield indicates whether the user information field is associated with a second communication protocol or a third communication protocol.

8. The trigger frame recipient of claim 1, wherein the version information subfield indicates the user information field is associated with a second communication protocol of the plurality of communication protocol versions different than the first communication protocol.

9. The trigger frame recipient of claim 1, wherein the plurality of communication protocols include a first communication protocol, a second communication protocol, and a third communication protocol, and wherein in a case that the processor determines the common information field is associated with the third communication protocol, a plurality of bits in the common information field have predetermined values to provide backwards compatibility with the first communication protocol or the second communication protocol.

10. The trigger frame recipient of claim 1, wherein the processor is further configured to cause:
decode the version information subfield; and
determine a first communication protocol associated with the version information subfield, wherein the processor is configured to determine the first communication protocol based on a second communication protocol of the trigger frame recipient.

11. The trigger frame recipient of claim 1, wherein the special user information field includes an indication of at least one of:
the presence of one or more follow up special user information fields that are present after the special user information field; or
the number of follow up special user information fields present after the special user information field.

12. The trigger frame recipient of claim 1, wherein a user information field of the one or more user information fields includes an indication of at least one of:
the presence of one or more follow up user information fields that are present after the user information field and are addressed to the same trigger frame recipient; or
the number of follow up user information fields that are addressed to the same trigger frame recipient and are present after the user information field.

13. The trigger frame recipient of claim 1, wherein a first user information field of the one or more user information fields is associated with a first association identification and a second user information field of the one or more user information fields is associated with a second association identification.

14. The trigger frame recipient of claim 13, wherein the second user information field refrains from including trigger dependent user information.

15. The trigger frame recipient of claim 1, wherein the common information field, the user information field, a follow-up user information field, the special user information field, or a follow-up special user information fields includes parameters associated with a non-primary channel access operation, a co-existence indication, or an intermediate frame check sequence (FCS).

16. A trigger frame transmitter in a wireless network, comprising:
a memory; and
a processor coupled to the memory, the processor configured to cause:
generate a trigger frame that solicits one or more responses from one or more trigger frame recipients, wherein each of the one or more trigger frame recipients are associated with a respective one of a plurality of communication protocol versions, wherein the trigger frame includes a common information field, one or more special user information fields, and one or more user information fields, wherein the common information field provides information that is common to the one or more trigger frame recipients of the trigger frame and each user information field provides information that is specific to a particular trigger frame recipient of the one or more trigger frame recipients, wherein a communication protocol version associated with the common information field is indicated based on (i) a first bit and a second bit of the common information field and (ii) a version information subfield of a special user information field, the version information subfield indicating a particular communication protocol version; and
transmit, to the one or more trigger frame recipients, the trigger frame.

17. The trigger frame transmitter of claim 16, wherein:
the first bit and the second bit of the common information field indicate whether the common information field is associated with a first communication protocol; and
the version information subfield indicates whether the common information field is associated with a second communication protocol or a third communication protocol.

18. The trigger frame transmitter of claim 16, wherein the version information subfield indicates the common information field is associated with a second communication protocol of the plurality of communication protocol versions different than the first communication protocol.

19. The trigger frame transmitter of claim 16, wherein a communication protocol version associated with a user information field of the one or more user information fields is indicated based on (i) the first bit of the common information field, (ii) a third bit of the user information field, and (iii) the version information subfield of the specific user information field.

20. The trigger frame transmitter of claim 19, wherein:
the first bit of the common information field and the third bit of the user information field indicate whether the user information is associated with a first communication protocol; and
the version information subfield indicates whether the user information field is associated with a second communication protocol or a third communication protocol.

21. The trigger frame transmitter of claim 16, wherein the plurality of communication protocols include a first communication protocol, a second communication protocol, and a third communication protocol, and wherein in a case that the processor determines the common information field is associated with the third communication protocol, a plurality of bits in the common information field have predetermined values to provide backwards compatibility with the first communication protocol or the second communication protocol.

22. The trigger frame transmitter of claim 16, wherein the special user information field includes an indication of at least one of:
the presence of one or more follow up special user information fields that are present after the special user information field; or
the number of follow up special user information fields present after the special user information field.

23. The trigger frame transmitter of claim 16, wherein a user information field of the one or more user information fields includes an indication of at least one of:
the presence of one or more follow up user information fields that are present after the user information field and are addressed to the same trigger frame recipient; or
the number of follow up user information fields that are addressed to the same trigger frame recipient and are present after the user information field.

24. The trigger frame transmitter of claim 22, wherein the user information field is associated with a first association identification and the one or more follow up user information fields are associated with a second association identification.

25. The trigger frame transmitter of claim 22, wherein the one or more follow up user information fields refrain from including trigger dependent user information.

26. The trigger frame of claim 16, wherein the common information field, the user information field, a follow-up user information field, the special user information field, or a follow-up special user information fields includes parameters associated with a non-primary channel access operation, a co-existence indication, or an intermediate frame check sequence (FCS).
